(19) United States
(12) Patent Application Publication
(10) Pub. No.: US 2026/0183757 A1
(43) Pub. Date: Jul. 2, 2026

(54) IMPROVED MIXED OXIDE COMPOSITIONS CONTAINING ALUMINA

(71) Applicant: Neo Chemicals & Oxides, LLC, Greenwood Village, CO (US)

(72) Inventors: Gary A. GRAMICCIONI, Athens, AL (US); Dimitrios PSARAS, Bound Brook, NJ (US); Benedict Hsu You WEI, Singapore (SG)

(73) Assignee: Neo Chemicals & Oxides, LLC, Greenwood Village, CO (US)

(21) Appl. No.: 19/436,981

(22) Filed: Dec. 30, 2025

Related U.S. Application Data
(60) Provisional application No. 63/739,885, filed on Dec. 30, 2024.

(51) Int. Cl. B01J 23/89; B01J 35/40; B01J 35/61; B01J 35/63; B01J 35/64; B01J 35/70; B01J 35/77

(52) U.S. Cl. CPC B01J 23/8946; B01J 35/40; B01J 35/613; B01J 35/633; B01J 35/635; B01J 35/651; B01J 35/733; B01J 35/77

(57) ABSTRACT

Disclosed herein are mixed oxide compositions containing mixed oxides of lanthanum, aluminum, a mixture of iron and strontium. These compositions optionally also may contain additional rare earth dopants that are not cerium, alkaline earth dopants, and transition metal dopants. These mixed oxide compositions surprisingly exhibit enhanced oxygen storage capacity (OSC) when measured at temperatures between 350° C. and 800° C., in particular between 450° C. and 800° C., even after aging at elevated temperatures. These mixed oxide compositions importantly contain a primary perovskite phase, which in one embodiment is LaAlO₃, and a secondary perovskite phase, which in one embodiment comprises a lanthanide, a transition metal, and alkaline earth mixed oxide. The compositions may be used as catalytic carriers which may be used in gas exhaust purification catalysts and/or as CO₂ conversion catalysts.

### CROSS REFERENCE TO RELATED APPLICATIONS

The present application claims priority to U.S. Provisional Application No. 63/739,885, filed Dec. 30, 2024, the complete disclosure of which is incorporated herein by reference in its entirety.

### FIELD OF THE INVENTION

This disclosure relates to mixed oxide compositions containing oxides of aluminum, lanthanum, and a mixture of iron and strontium. These compositions optionally also may contain silicon, as well as additional rare earth dopants. These mixed oxide compositions surprisingly exhibit enhanced light off, oxygen storage capacity (OSC), and thermal stability even after aging at elevated temperatures.

### INTRODUCTION

Catalytic materials including alumina have utility in a number of fields, including abatement of nitrogen oxides, primarily NO and NO₂ (referred to as NOₓ), carbon monoxide (CO), hydrocarbons (HC), such as methane (CH₄) and non-methane hydrocarbons (NMHC), other pollutants from gasoline, compressed natural gas (CNG), and diesel fueled internal combustion engines, such as on-road vehicles, cars, buses and trucks and other off-road gasoline, CNG and diesel engines used in utility vehicles, recreational vehicles and stationary source power generation applications. Emission standards for unburned hydrocarbons, carbon monoxide, and nitrogen oxide contaminants have been set by various worldwide government agencies and must be met or severe penalties will be imposed. To meet such standards, catalytic converters typically are placed in the exhaust gas line of these emission sources. Exhaust gas flows through a catalytic converter and harmful HC and CO are converted into CO₂ and H₂O. NOₓ is preferentially converted into N₂ and O₂ with any unconverted CO, HC, and NOₓ emitted from the exhaust tailpipe and into the atmosphere as primary pollutants. Catalytic converters contain mixtures of base metal oxides and Platinum Group Metals (PGM).

An emission source catalyst used to convert harmful gases, like hydrocarbons (HC), carbon monoxide (CO) and nitrogen oxides (NOₓ) into less harmful gases like H₂O, N₂ and CO₂ typically includes one or more precious metals/platinum group metals (PGM) combined with high surface area base metal oxide/mixed oxide carrier materials. Catalysts, like Fischer Tropsch catalysts for example, can also be used to create new molecules, via mixtures of carbon dioxide and hydrogen gases (CO₂+H₂). When promoted, an oxide carrier can be used to store and release oxygen and/or promote precious metal function to regulate catalysis depending on the chemical reaction being targeted.

There continues to be a need for effective mixed oxide supports for these platinum group metal catalysts to convert emissions more efficiently. Further, these mixed oxide carrier materials to date primarily have focused on development of materials suitable for operating at high temperatures, which, for example, are typical of internal combustion engines. An example of this are hybrid internal combustion/electric vehicles which are becoming more abundant, where it is increasingly important to develop catalytic materials with improved oxygen storage capacity (OSC) characteristics at low temperatures to handle increased on/off cycling and improved conversion of cold start hydrocarbons while maintaining industry standard high temperature performance and emissions control. Another example is boosting OSC at higher temperatures by promoting OSC materials and precious metal function thus expanding the operating window of a typical three-way conversion (TWC) and four-way conversion (FWC) catalysts.

### SUMMARY

Disclosed herein are mixed oxide compositions comprising aluminum, rare earth elements, alkaline earth elements, transition metal elements, and optionally metalloids, all on an oxide basis. The compositions may be used as catalytic carriers, which may be used in gas exhaust purification catalysts and/or as support materials for the creation of new molecules from CO₂ in the exhaust gas. In particular, the compositions comprise lanthanum and alumina La₂O₃/Al₂O₃, with high amounts of lanthanum than known compositions. These compositions also comprise strontium and iron, preferably iron (III), on an oxide basis.

In one embodiment, the mixed oxide composition comprises a) about 3 to about 50 wt. %, or in one embodiment from 20 to 50 wt. % lanthanum on an oxide basis; b) about 50 to about 79 wt. % aluminum on an oxide basis; c) about 0.05 wt. % to about 15.00 wt. %, or in one embodiment about 0.065 wt. % to about 4.00 wt. % iron on an oxide basis; d) about 0.015 wt. % to about 5.00 wt. %, or in one embodiment about 0.015 wt. % to about 1.00 wt. % strontium on an oxide basis. In this mixed oxide composition optionally up to 99 wt. % of the lanthanum can be substituted with a different rare earth element, wherein the total amount of lanthanum and the different/optional rare earth are in an amount of about 3 to about 50 wt. % on an oxide basis. In certain embodiments this different/optional rare earth element can be selected from the group consisting of neodymium, yttrium, praseodymium, samarium, gadolinium, and mixtures thereof. In this mixed oxide composition optionally up to 99 wt. % of the iron can be substituted with any transition metal (TM) dopant, wherein the total amount of iron and the transition metal dopant when present are in an amount of about 0.05 wt. % to about 15.00 wt. %, or in one embodiment about 0.065 to about 4.0 wt. % on an oxide basis. In certain embodiments the transition metal (TM) dopant is selected from the group consisting of manganese, chromium, cobalt, vanadium, copper, titanium, zinc, and mixtures thereof. In this mixed oxide composition optionally up to 99 wt. % of the strontium can be substituted with an alkaline earth (AE) metal dopant, wherein the total amount of strontium and the alkaline earth metal dopant when present are in an amount of about 0.015 wt. % to about 5.00 wt. %, or in one embodiment about 0.015 wt. % to about 1.00 wt. % on an oxide basis. In certain embodiments the alkaline earth (AE) metal dopant is selected from the group consisting of magnesium, calcium, and mixtures thereof, wherein the total amount of strontium and the alkaline earth metal dopant when present are in an amount of about 0.015 wt. % to about 5.00 wt. %, or about 0.015 to about 1.00 wt. % on an oxide basis.

In one preferred embodiment, the mixed oxide composition comprises a) about 3 to about 40 wt. % lanthanum on an oxide basis or in one embodiment from about 10 to about 40 wt. % lanthanum on an oxide basis, or in one embodiment from about 15 to about 40 wt. % lanthanum on an oxide basis; b) about 50 to about 77 wt. % aluminum on an oxide basis; c) about 0.05 wt. % to about 15.00 wt. % iron on an oxide basis or in one embodiment from about 0.05 wt. % to about 10.00 wt. % iron on an oxide basis; d) about 0.02 wt. % to about 5.00 wt. % strontium on an oxide basis or in one embodiment from about 0.02 wt. % to about 3.00 wt. % strontium on an oxide basis. In this mixed oxide composition optionally up to 99 wt. % of the lanthanum can be substituted with a different rare earth element, wherein the total amount of lanthanum and the different/optional rare earth are in an amount of about 3 to about 40 wt. % on an oxide basis. In certain embodiments this different/optional rare earth element can be selected from the group consisting of neodymium, yttrium, praseodymium, samarium, gadolinium, and mixtures thereof. In this mixed oxide composition optionally up to 99 wt. % of the iron can be substituted with any transition metal (TM) dopant, wherein the total amount of iron and the transition metal dopant when present are in an amount of about 0.05 wt. % to about 15.00 wt. % on an oxide basis. In certain embodiments the transition metal (TM) dopant is selected from the group consisting of manganese, chromium, cobalt, vanadium, copper, titanium, zinc, and mixtures thereof. In this mixed oxide composition optionally up to 99 wt. % of the strontium can be substituted with an alkaline earth (AE) metal dopant, wherein the total amount of strontium and the alkaline earth metal dopant when present are in an amount of about 0.02 wt. % to about 5.00 wt. % on an oxide basis. In certain embodiments the alkaline earth (AE) metal dopant is selected from the group consisting of magnesium, calcium, and mixtures thereof, wherein the total amount of strontium and the alkaline earth metal dopant when present are in an amount of about 0.02 wt. % to about 5.00 wt. % on an oxide basis.

The mixture of iron and strontium surprisingly provides the mixed oxide composition with improved OSC even after aging at elevated temperatures.

The mixed oxide compositions as disclosed herein contain less than 0.01 wt. % barium, cerium, mercury, and cadmium, and in particular embodiments, the mixed oxide compositions contain no measurable amount of barium, cerium, mercury, and cadmium.

In one embodiment, the mixed oxide composition exhibits a primary perovskite phase and a secondary perovskite phase. The primary perovskite phase can be LaAlO₃, where Ln is lanthanum (La), which as described herein can be substituted with optional rare earths, except for cerium (Ce). In certain embodiments, the optional rare earth is selected from the group consisting of neodymium, yttrium, praseodymium, samarium, gadolinium, and mixtures thereof. The primary perovskite phase is identified by XRD both fresh (as manufactured at 1050±50° C.) and after aging at 1100±50° C. for 4 to 10 hrs in air via the primary XRD peak that occurs at 33°@2θ. The primary X-ray diffraction peaks at 2θ typically fall between 31° to 34°, with 33° being a point of reference for the LaAlO₃ primary peak.

The secondary perovskite phase can be of the formula Ln_{(1-X)}AE_{X}TMO₃, LnAl_{(1-y)}TM_{(y)}O₃ or Ln₍₁₋ₓ₎AE₍ₓ₎Al_{(1-y)}TM_{(y)}O₃ where Ln is lanthanum (La), which as described herein can be substituted with optional rare earths, except for cerium (Ce). In certain embodiments, the optional rare earth is selected from the group neodymium (Nd), praseodymium (Pr), yttrium (Y), samarium (Sm) or gadolinium (Gd), or a mixture thereof. AE is strontium (Sr), which as described herein can be substituted with an alkaline earth metal dopant, except for barium (Ba). In certain embodiments, the alkaline earth metal dopant is selected from the group consisting of magnesium (Mg), calcium (Ca), and mixtures thereof. In the formula x is the molar ratio of AE, with x being from 0.001 to 0.999 and in the formula(s) containing y, the molar ratio TM, with y being from 0.001 to 0.999. TM is iron (Fe), which as described herein can be substituted with a transition metal dopant, except for mercury and cadmium. In certain embodiments, the transition metal dopant is selected from the group consisting of manganese (Mn), chromium (Cr), cobalt (Co), vanadium (V), copper (Cu), titanium (Ti), zinc (Zn), and mixtures thereof.

In one embodiment, the secondary perovskite phases can be fresh/as manufactured and/or after aging at 1100° C. for 10 hrs in air.

As the amounts of both TM and AE increase in the formulation, LaFeO₃, La₍₁₋ₓ₎Sr₍ₓ₎FeO₃ and SrFeO₃ can be present. In the formula x is the molar ratio of AE, with x being from 0.001 to 0.999.

In another embodiment, x in the mixed oxide compositions can range from 0 to 1. In one embodiment, y in the mixed oxide compositions can range from 0 to 1. In one embodiment, both x and y in the mixed oxide compositions range from 0 to 1.

As described herein, the mixed oxide composition contains less than 0.01 wt. % Ba, Ce, Hg, and Cd, and preferably contains no measurable amount of Ba, Ce, Hg, and Cd.

Additionally disclosed herein are supported catalysts or catalyst compositions comprising the present mixed oxide compositions. The catalyst generally further comprises platinum group metals (PGM).

Further disclosed is a dispersion or suspension comprising the mixed oxide composition as disclosed herein and a Platinum Group Metal. In certain of these embodiments, the Platinum Group Metal (PGM) can be selected from the group consisting of platinum (Pt), palladium (Pd), rhodium (Rh), iridium (Ir), ruthenium (Ru), and mixtures thereof.

As described above, the mixed oxide compositions comprise in a preferred embodiment a) about 3 to about 40 wt. % lanthanum on an oxide basis or in one embodiment from about 10 to about 40 wt. % lanthanum on an oxide basis, or in one embodiment from about 15 to about 40 wt. % lanthanum on an oxide basis; b) about 50 to about 77 wt. % aluminum on an oxide basis; c) about 0.05 wt. % to about 15.00 wt. % iron on an oxide basis or in one embodiment from about 0.05 wt. % to about 10.00 wt. % iron on an oxide basis; d) about 0.02 wt. % to about 5.00 wt. % strontium on an oxide basis or in one embodiment from about 0.02 wt. % to about 3.00 wt. % strontium on an oxide basis. In this mixed oxide composition optionally up to 99 wt. % of the lanthanum can be substituted with a different rare earth element, wherein the total amount of lanthanum and the different/optional rare earth are in an amount of about 3 to about 40 wt. % on an oxide basis. In certain embodiments this different/optional rare earth element can be selected from the group consisting of neodymium, yttrium, praseodymium, samarium, gadolinium, and mixtures thereof. In this mixed oxide composition optionally up to 99 wt. % of the iron can be substituted with any transition metal (TM) dopant, wherein the total amount of iron and the transition metal dopant when present are in an amount of about 0.05 to about 15.0 wt. % on an oxide basis. In certain embodiments the transition metal (TM) dopant is selected from the group consisting of manganese, chromium, cobalt, vanadium, copper, titanium, zinc, and mixtures thereof. In this mixed oxide composition optionally up to 99 wt. % of the strontium can be substituted with an alkaline earth (AE) metal dopant, wherein the total amount of strontium and the alkaline earth metal dopant when present are in an amount of about 0.02 to about 5.00 wt. % on an oxide basis. In certain embodiments the alkaline earth (AE) metal dopant is selected from the group consisting of magnesium, calcium, and mixtures thereof, wherein the total amount of strontium and the alkaline earth metal dopant when present are in an amount of about 0.02 to about 5.00 wt. % on an oxide basis.

In certain embodiments, the suspension contains rhodium or palladium as the Platinum Group Metal (PGM). In further specific embodiments, the impregnation comprises about 95 wt. % to about 99.5 wt. % of the mixed oxide composition.

When the mixture or “impregnated powder” as disclosed herein is dried and calcined, the dried and calcined material exhibits an improved oxygen storage capacity (OSC), increased thermal stability, and in particular improved light off and oxygen storage capacity (OSC) especially at elevated temperatures post aging at 1100° C. for 10 hrs in air and measured at 450 to 750° C.

### BRIEF DESCRIPTION OF THE FIGURES

FIG. 1 is a graph and table demonstrating 30 wt. % to 60 wt. % LaAlO₃ as optimum compositional window to achieve fresh BET≥50 m²/g with “fresh” defined as “as-is”/calcined at manufacturing conditions of 1100±50° C. The LaAlO₃ crystallite size within this window will be between about 10 to about 80 nm.

FIG. 2A is an XRD diffractogram demonstrating LaAlO₃ perovskite phase is the primary phase as manufactured/calcined at 1100±50° C.

FIG. 2B demonstrates linearity based on intensity measurements at 33°, 2θ for calculated LaAlO₃ content between ˜25 wt. % to 65 wt. %

FIG. 3A is a XRD diffractogram of Example 4 mixed oxide as manufactured.

FIG. 3B is a XRD diffractogram of Example 4 mixed oxide calcined at 1100±50° C. for 10 hrs in air.

FIG. 3C is a XRD diffractogram of Example 7 mixed oxide as manufactured.

FIG. 3D is a XRD diffractogram of Example 7 mixed oxide calcined at 1100±50° C. for 10 hrs in air.

FIG. 4A is a XRD diffractogram of Example 7 mixed oxide as manufactured, demonstrating the location of the primary and secondary peaks which identify the primary perovskite as LaAlO₃.

FIG. 4B is showing the location of a second peak identifying the primary perovskite as LaAlO₃.

FIG. 4C is a XRD diffraction of Example 7 mixed oxide as aged at 1100° C. for 10 hrs in air.

FIG. 4D shows the location of a second peak identifying the primary perovskite as LaAlO₃.

FIG. 4E demonstrates insertion, peak broadening, peak location shifting to a lower angle when measured at 20 and formation of both transitional secondary perovskites and formation of LaFeO₃.

FIG. 5A demonstrates a reference diffractogram for LaFeO₃ as a secondary perovskite which has a primary diffraction peak between 32°-33°, 2θ.

FIG. 5B demonstrates a reference diffractogram for SrFeO₃ as a secondary perovskite which has a primary diffraction peak between 32°-33°, 2θ.

FIG. 6A demonstrates how the LaAlO₃ peak position shifts as Fe and Sr insert into the lattice for fresh, as manufactured LaAlO₃.

FIG. 6B demonstrates how the LaAlO₃ peak position shifts as Fe and Sr insert into the lattice for LaAlO₃ aged at 1100° C. for 10 hrs in air.

FIG. 7A graphically demonstrates how the full width at half maximum peak height (FWHM) increases as Fe and Sr insert into the fresh primary perovskite lattice. FWHM is a measurement of strain on the lattice and distortion it causes.

FIG. 7B graphically demonstrates how the full width at half maximum peak height (FWHM) increases as Fe and Sr insert into the aged primary perovskite lattice.

FIG. 8. shows TEM/EDs photomicrographs demonstrating large crystal LaAlO₃, with incorporation of Fe to form LaFeO₃ and/or intermediate phases. Other regions indicate strong co-localization of Fe and Sr, suggesting that these elements are well mixed and formed a homogeneous phase, i.e., SrFeO₃. The TEM/EDS Photomicrographs support the XRD findings.

FIG. 9A shows a graph that demonstrates the relative improvement the combination of primary and secondary perovskite phases has on OSC when measured at 450° C., 600° C., 700° C., and 750° C. post aging at 1100° C. for 10 hrs air. Example 1 contains only LaAlO₃.

FIG. 9B shows a graph that demonstrates the relative improvement the combination of primary and secondary perovskite phases has on OSC when measured at 450° C., 600° C., 700° C., and 750° C. post 1100° C. for 10 hrs in air Lean/Rich aging. Example 1 contains only LaAlO₃.

FIG. 10A demonstrates H₂-TPR, Temperature Programmed Reduction (TPR), with the results demonstrating Example 4 mixed oxide has the lowest PRT (implied lower light off temperature) and highest mmol/g total H₂ (OSC). The results support the OSC test data of FIGS. 9A and 9B.

FIG. 10B shows the H₂-TPR results for Example 1.

FIG. 10C shows the H₂-TPR results for Example 4.

FIG. 10D shows the H₂-TPR results for Example 7.

FIG. 11A compares BET surface area stability of Examples 1-7 at different aging temperatures and conditions.

FIG. 11B compares BET surface area stability of Examples 1-7 at different aging temperatures and conditions with PGM addition.

FIG. 12 demonstrates BJH pore volume measurements comparing Examples 1-7 at different aging temperatures and conditions.

### DETAILED DESCRIPTION

This disclosure generally relates to mixed oxide compositions containing aluminum, lanthanum, iron, strontium, and optionally additional rare earth dopants. This disclosure also relates to a material comprising platinum group metals (PGM) and the mixed oxide compositions described herein, as well as supported catalysts prepared from the described mixed oxides. The described mixed oxides are useful for treating exhaust gases from internal combustion engines and exhibit enhanced oxygen storage capacity (OSC) and light off, even after aging at elevated temperatures.

Before the compositions, catalysts, and methods are disclosed and described in detail, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting. It must be noted that, as used in this specification, the singular forms “a,” “an,” and “the” include plural referents unless the context clearly dictates otherwise. Thus, for example, reference to “a trivalent dopant” is not to be taken as quantitatively or source limiting, reference to “a step” may include multiple steps, reference to “producing” or “products” of a reaction or treatment should not be taken to be all of the products of a reaction/treatment, and reference to “treating” may include reference to one or more of such treatment steps.

Numerical values with “about” or “approximately” include typical experimental variances. As used herein, the terms “about” and “approximately” are used interchangeably and mean within a statistically meaningful range of a value, such as a stated weight percentage, surface area, concentration range, time frame, temperature and the like. Such a range can be within 10%, and even more typically within 5% of the indicated value or range. Sometimes, such a range can be within the experimental error typical of standard methods used for the measurement and/or determination of a given value or range. The allowable variation encompassed by the term “about” will depend upon the particular system under study, and can be readily appreciated by one of ordinary skill in the art. Whenever a range is recited within this application, at least every whole number integer within the range is also contemplated as an embodiment of the invention.

As used herein, light-off temperature refers to a lower H₂ TPR peak reduction temperature which indicates that the catalyst reduction rate is maximum, a lower peak reduction temperature signifies catalyst will light-off at a lower temperature.

The present disclosure relates to mixed oxide compositions having improved oxygen storage capacity (OSC), light-off, and thermal stability, even after aging at elevated temperatures. These mixed oxide compositions are mixed oxides of aluminum, lanthanum, strontium and iron. The mixed oxide compositions are in powder form. Within the mixed oxide composition, the individual components are intimately mixed.

As disclosed herein, these mixed oxide compositions importantly contain iron and strontium (as oxides) and this mixture of iron and strontium surprisingly provides the mixed oxide composition with improved light off, OSC and thermal stability even after aging at elevated temperatures, in particular improved OSC at temperatures greater than 350° C.

In certain embodiments, the mixed oxide compositions also contain an amount of additional rare earth dopant. This additional rare earth dopant can be selected from any of the rare earths or mixtures thereof, except for cerium. In certain embodiments, the additional rare earth dopant is selected from the group consisting of neodymium, yttrium, praseodymium, samarium, gadolinium, and mixtures thereof. In particular embodiments, the additional rare earth dopant is neodymium, praseodymium, yttrium, or mixtures thereof.

The mixed oxide composition is described as a mixture of oxides of aluminum, lanthanum, iron, strontium, and optionally additional rare earth dopants and the amounts of these individual components are measured (and reported) as oxides. However, it is not excluded that any of these components may be present in the form of hydroxides and/or oxyhydroxides and preferably mixed perovskite structures. The compositional proportions of these components are determined by a plasma torch analytical technique using optical emission spectroscopy, as described in greater detailed within the Examples section. This technique measures and reports the components by weight percent on an equivalent oxide basis with respect to the total weight of the mixed oxide composition. This technique provides accurate elemental analysis of lower, but important, amounts of iron and strontium present in the disclosed mixed oxide compositions as described herein.

These mixed oxide compositions as disclosed herein in one embodiment comprise about 50 to about 77 wt. % aluminum on an oxide basis. These mixed oxide compositions also contain about 3 to about 40 wt. % lanthanum on an oxide basis. In certain of these embodiments, the mixed oxide compositions contain about 10 to about 40 wt. % lanthanum on an oxide basis or in particular from about 15 to about 40 wt. % lanthanum on an oxide basis. The mixed oxide compositions further contain about 0.05 wt. % to about 15.0 wt. % iron on an oxide basis. In certain of these embodiments, the mixed oxide compositions contain about 0.05 wt. % to about 10.00 wt. % iron on an oxide basis. The mixed oxide compositions further contain about 0.02 wt. % to about 5.0 wt. % strontium on an oxide basis. In certain of these embodiments, the mixed oxide compositions contain about 0.02 wt. % to about 3.00 wt. % strontium on an oxide basis. Any of the amounts of lanthanum, iron, and strontium may be utilized with one another such that the composition overall contains aluminum, lanthanum, iron, and strontium.

Any suitable form of aluminum can be used. The aluminum can be in the form of transitional alumina comprising γ-Al₂O₃, δ-Al₂O₃ and/or θ-Al₂O₃.

As described herein, the lanthanum can be substituted up to 99% by weight with another rare earth dopant selected from the group consisting of neodymium, yttrium, praseodymium, samarium, gadolinium and mixtures thereof. The total amount of lanthanum and any rare earth dopant when present are in an amount of about 3 to about 40 wt. % on an oxide basis.

In one embodiment, the mixed oxide composition comprises, or consists essentially of, about 72% aluminum, 20 wt. % lanthanum, 6.5% iron and 1.5% Sr, all on an oxide basis.

Additionally, the iron can be substituted up to 99% by weight with a transition metal (TM) dopant selected from the group consisting of manganese, chromium, cobalt, vanadium, copper, titanium, zinc and mixtures thereof. The total amount of iron and any transition metal dopant when present are in an amount of about 0.05 to about 15.0 wt. % on an oxide basis.

Further the strontium can be substituted up to 99% by weight with an alkaline earth (AE) metal dopant selected from the group consisting of magnesium, calcium, and mixtures thereof. The total amount of strontium and alkaline earth metal dopant when present are in an amount of about 0.02 to about 5.00 wt. % on an oxide basis.

Even though the amounts of iron and strontium can be small, these small amounts impart surprisingly improved properties to the disclosed mixed oxide compositions. The mixture of iron and strontium in combination with lanthanum surprisingly provides the mixed oxide composition with improved OSC even after aging at elevated temperatures, and in particular improved OSC at higher temperatures. These improved properties are provided when lanthanum, strontium and iron are present and present in the recited amounts. It is important that the mixed composition as disclosed herein contains that mixture of aluminum, lanthanum, strontium and iron in the recited amounts.

The composition optionally can contain 0.5 to about 5 wt. % silicon, germanium, tin, or a mixture thereof on an oxide basis. In one embodiment, the composition comprises from about 0.5 wt. % to about 5 wt. % silicon and in certain embodiments 0.5 wt. % to about 5 wt. % SiO₂.

Silicon may be present in small amounts, but it must be pointed out that today's gasoline internal combustion engines possess very tightly calibrated emission controls either centered around stoichiometric or slightly on the lean side (gasoline direct injection, GDI). This is important when using silicon dioxide as it is known to migrate on the rich side of stoichiometric when oxygen becomes starved. This, of course, is not an issue when it comes to diesel engines as they operate on the far lean side (excess oxygen). In the past gasoline internal combustion engine emission control calibrations were considered loose meaning they had broad swings between rich and lean around stoichiometric making silicon more likely to migrate within the washcoat structure. This was even noted with cordierite substrates where silicon migrated from the cordierite structure into the washcoat negatively impacting platinum group metal (PGM) function. Today's vehicles are even equipped with control systems which prevent excessive fuel from entering the combustion chamber when under load (towing and traveling up hills—i.e., when the vehicle is under load). This is done primarily to reduce harmful emissions from entering the environment. One can envision that this becomes even more controlled with use of autonomous vehicles removing human to human variability from the equation relative to acceleration and deceleration events.

The mixed oxide composition comprises the above-noted components within the amounts indicated, but in certain embodiments it also may comprise other elements and/or small amounts of impurities. In other embodiments, the mixed oxide composition consists essentially of the above-noted components, and the amounts of the individual components will vary so that the total amount is about 100% of the mixed oxide composition.

The mixed oxide compositions may contain trace amounts of impurities. These impurities are typically present in an amount of about 1% by weight or less (to about zero or to an amount that is undetectable) based on the total weight of the mixed oxide composition. These impurities include residual solvents, salts, other metals, and the like. These other metals include those commonly found in water, such as magnesium, calcium, sodium, and the like. These impurity amounts (of about 1% by weight to about zero or to an amount that is undetectable) may be present in any of the described embodiments of the mixed oxide compositions. When present and detectable, any impurities may be present in an amount of about 100 ppm or less unless as specified in the compositional claims.

Importantly, the mixed oxide compositions as disclosed herein contain less than 0.01 wt. % barium (Ba), cerium (Ce), mercury (Hg), and cadmium (Cd). In certain embodiments, the mixed oxide compositions as disclosed herein contain no measurable amount of Ba, Ce, Hg, and/or Cd. In certain of these embodiments, the mixed oxide compositions as disclosed herein contain no measurable amount of Ba, Ce, Hg, and Cd—as such, no measurable amount of any of these four.

In a specific embodiment, the mixed oxide compositions as disclosed herein comprise a) about 50 to about 77 wt. % aluminum on an oxide basis; b) about 3 to about 40 wt. % lanthanum on an oxide basis or in one embodiment from about 10 to about 40 wt. % lanthanum on an oxide basis, or in one embodiment from about 15 to about 40 wt. % lanthanum on an oxide basis; c) about 0.05 wt. % to about 15.0 wt. % iron on an oxide basis or in one embodiment from about 0.05 wt. % to about 10.00 wt. % iron on an oxide basis; d) about 0.02 wt. % to about 5.00 wt. % strontium on an oxide basis or in one embodiment from about 0.02 wt. % to about 3.00 wt. % strontium on an oxide basis; and e) optionally an additional rare earth dopant that is not cerium and is preferably selected from the group consisting of neodymium, yttrium, praseodymium, samarium, gadolinium, and mixtures thereof. The total amount of the lanthanum and additional rare earth dopant are in an amount of about 3 to about 40 wt. % on a total rare earth oxide basis. In certain of these embodiments, the amounts of the individual components will vary so that the total amount is about 100% of the mixed oxide composition.

In another specific embodiment, the mixed oxide compositions as disclosed herein comprise a) about 50 to about 77 wt. % aluminum on an oxide basis; b) about 3 to about 50 wt. % lanthanum on an oxide basis or in one embodiment from about 10 to about 40 wt. % lanthanum on an oxide basis, or in one embodiment from about 15 to about 40 wt. % lanthanum on an oxide basis; c) about 0.05 wt. % to about 15.0 wt. % iron on an oxide basis or in one embodiment from about 0.05 wt. % to about 10.00 wt. % iron on an oxide basis; d) about 0.02 wt. % to about 5.00 wt. % strontium on an oxide basis or in one embodiment from about 0.02 wt. % to about 3.00 wt. % strontium on an oxide basis; and e) optionally an additional rare earth dopant that is not cerium and is preferably selected from the group consisting of neodymium, yttrium, praseodymium, samarium, gadolinium, and mixtures thereof. The total amount of the lanthanum and additional rare earth dopant are in an amount of about 3 to about 40 wt. % on a total rare oxide basis. In particular of these embodiments, the additional rare earth dopant is yttrium. In certain of these embodiments, the mixed oxide composition contains the additional rare earth dopant in an amount of about 0.5 to about 39 wt. % on a total rare earth oxide basis. And in other of these embodiments, the mixed oxide composition contains about zero additional rare earth dopant. In specific embodiments, the amounts of the individual components will vary so that the total amount is about 100% of the mixed oxide composition.

As described herein, the mixed oxide compositions containing lanthanum, iron, strontium and aluminum have improved light off, OSC and stability, even after aging at elevated temperatures, and in particular, enhanced oxygen storage capacity (OSC). OSC is measured as described within the Examples.

After aging at 1100° C. for 10 hrs in air, the mixed oxide composition as disclosed herein may exhibit an Oxygen Storage Capacity (OSC) at about 350° C. to about 800° C.; or at 450° C. to about 800° C.; or at 600° C. to about 800° C.; or about 700° C. to about 800° C.; or at 750° C. to about 800° C., that is about 3 to 86 times higher, in the absence of platinum group metals (PGM), than alumina or lanthanum alumina not containing a mixture of lanthanum, iron, strontium, and aluminum oxides also in the absence of platinum group metals. As defined above, “an identical composition not containing a mixture of iron and strontium” means a mixed oxide composition containing the same components (i.e., aluminum, lanthanum and any optional rare earth dopants) in about the same constitutional amounts, except not containing strontium and iron, in which the amount of aluminum and lanthanum are varied to adjust for the absence of the strontium and iron. In certain embodiments, after aging at 1100° C. for 10 hrs in air, the mixed oxide composition as disclosed herein may exhibit an Oxygen Storage Capacity (OSC) at about 350° C. to about 800° C. that is about 10 to 90 times, or in one embodiment about 3 to 86 times higher than a comparable lanthanum aluminum mixed oxide composition not containing a mixture of iron and strontium. This is true both with or without Pt, Pd, or Rh added to the mixed oxide. As described, this improved OSC is particularly enhanced at temperatures greater than 350° C. As such, these improvements may be particularly evident at temperatures of about 400° C. to about 800° C., or 450° C. to about 800° C.

Any of these improved OSC characteristics may be combined with one another and may be combined with any of the above-described embodiments of the mixed oxide compositions and/or with any of the below described properties.

The mixed oxide compositions also may exhibit other advantageous physical properties, both as prepared and after aging at elevated temperatures.

As described above, the mixed oxide compositions contain iron and strontium, importantly such that fresh/as manufactured and after aging at elevated temperatures a primary and secondary perovskite phase is present. Perovskite phases are determined by XRD both fresh/as manufactured and after aging at 1100° C. for 10 hrs in air.

In specific embodiments, both fresh/as manufactured and after aging at 1100° C. for 10 hrs in air, the LnAlO₃ perovskite compositions as disclosed herein may have a crystallite size of 5 nm to about 80 nm, or about 20 nm to about 80 nm, or in one embodiment from about 20 nm to about 70 nm. Any of these crystalline phase embodiments may be combined and may be combined with any of the above-described embodiments of the mixed oxide compositions and/or with any of the below described properties.

As described herein formation of a primary and a secondary perovskite phase is desirable.

The mixed oxide compositions further may exhibit an advantageous BET surface area. BET surface area is measured as described within the Examples. In certain embodiments, the mixed oxide compositions as disclosed herein exhibit a fresh BET surface area between about 30 and about 100 m²/g, or in one embodiment from about 35 m²/g to about 80 m²/g. As described herein “fresh” means “as prepared” or “as manufactured” and is without any additional aging at elevated temperatures.

In certain embodiments, these mixed oxide compositions exhibit after aging at 1000° C. for 10 hrs in air, a BET surface area of about 30 m²/g to about 75 m²/g, or in one embodiment about 35 to about 70 m²/g. In certain embodiments, these mixed oxide compositions exhibit after aging at 1100° C. for 10 hrs in air, a BET surface area of about 30 m²/g to about 65 m²/g, or in one embodiment about 35 to about 60 m²/g.

In one embodiment, the mixed oxide composition exhibits a BET surface area after aging at 1200° C. for 2 hrs in air of about 15 m²/g to about 65 m²/g. In certain embodiments, the mixed oxide composition exhibits a BET surface area after aging at 1200° C. for 2 hrs in air of about 30 m²/g to 50 m²/g. In particular embodiments, the mixed oxide composition exhibits a BET surface area of about 30 m²/g after aging at 1200° C. for 2 hrs in air.

Any of these BET surface areas embodiments may be combined and may be combined with any of the above-described embodiments of the mixed oxide compositions.

The mixed oxide compositions further may exhibit an advantageous particle size. Particle size is measured as described within the Examples. In certain embodiments, the mixed oxide compositions have a particle size characterized by a D₉₀ of about 6 μm to about 30 μm and a D₁₀ of about 1 μm to about 4 μm; or in one embodiment a D₉₀ of about 10 μm to about 20 μm and a D₁₀ of about 1 to about 3 μm.

Pore size is an important physical characteristic of the mixed oxide compositions. Pore size is measured as described within the Examples. Pores allow for diffusion of low molecular weight and high molecular weight macromolecule gas phase reactants. The mixed oxide compositions may exhibit advantageous pore sizes as prepared (after the initial thermal treatment/calcination associated with the manufacturing process) ranging from about 50 to 200 nm in diameter, and in one embodiment from about 75 to 200 nm in diameter. Optimizing the pore size is important because the pore size needs to be sufficient for diffusion of the harmful gases.

In one embodiment, the mixed oxide composition has a nitrogen pore volume as measured by BJH method of about 0.1 cm³/g, to about 0.6 cm³/g, or in one embodiment about 0.2 cm³/g to about 0.6 cm³/g both fresh/as manufactured and after aging at 1100° C. for 10 hrs in air. A similar trend is observed when aged under Lean/Rich conditions at 1000° C. for 10 hrs

In one embodiment, the mixed oxide composition exhibits a primary perovskite phase and a secondary perovskite phase. The primary perovskite phase can be LaAlO₃, where Ln is lanthanum (La), which as described herein can be substituted with optional rare earths, except for cerium (Ce). In certain embodiments, the optional rare earth is selected from the group consisting of neodymium, yttrium, praseodymium, samarium, gadolinium, and mixtures thereof. The primary perovskite phase is identified by XRD both fresh (as manufactured at 1050±50° C.) and after aging at 1100±50° C. for 4 to 10 hrs in air via the primary XRD peak that occurs at 33°@2θ. The primary X-ray diffraction peaks at 2θ typically fall between 31° to 34°, with 33° being a point of reference for the LaAlO₃ primary peak.

The secondary perovskite phase can be of the formula Ln₍₁₋ₓ₎AE_{X}TMO₃, LnAl_{(1-y)}TM_{(y)}O₃ or Ln₍₁₋ₓ₎AE₍ₓ₎Al_{(1-y)}TM_{(y)}O₃ where Ln is lanthanum (La), which as described herein can be substituted with optional rare earths, except for cerium (Ce). In certain embodiments, the optional rare earth is selected from the group neodymium (Nd), praseodymium (Pr), yttrium (Y), samarium (Sm) or gadolinium (Gd), or a mixture thereof. AE is strontium (Sr), which as described herein can be substituted with an alkaline earth metal dopant, except for barium (Ba). In certain embodiments, the alkaline earth metal dopant is selected from the group consisting of magnesium (Mg), calcium (Ca), and mixtures thereof. In the formula x is the molar ratio of AE, with x being from 0.001 to 0.999 and in the formula(s) containing y, the molar ratio TM, with y being from 0.001 to 0.999. TM is iron (Fe), which as described herein can be substituted with a transition metal dopant, except for mercury and cadmium. In certain embodiments, the transition metal dopant is selected from the group consisting of manganese (Mn), chromium (Cr), cobalt (Co), vanadium (V), copper (Cu), titanium (Ti), zinc (Zn), and mixtures thereof.

Thus, in one embodiment, the mixed oxide composition exhibits a primary LaAlO₃ perovskite phase and additional perovskite phases fitting the formula, LaAl_{(1-y)}Fe_{y}O₃ or La₍₁₋ₓ₎Sr₍ₓ₎Al_{(1-y)}Fe_{(y)}O₃ with the primary X-ray diffraction peaks at 2θ typically falling at about 33° as the LaAlO₃ primary peak, and x is the molar ratio of Sr and is about 0.001 to about 0.999 and y is the molar ratio of Fe and is about 0.001 to about 0.999. In another embodiment, the mixed oxide composition includes a primary phase LnAlO₃ and additional perovskite phases fitting the general formulae Ln₍₁₋ₓ₎AE_{X}TMO₃, LnAl_{(1-y)}TM_{(y)}O₃ or Ln₍₁₋ₓ₎AE₍ₓ₎Al_{(1-y)}TM_{(y)}O₃ where Ln is lanthanum, neodymium, yttrium, praseodymium, samarium, gadolinium or a mixture thereof; AE is strontium, magnesium, calcium or a mixture thereof; and TM is iron, manganese, or chromium, and x is the molar ratio amount of AE with x being about 0.001 to about 0.999 and y is the molar ratio of TM with y from about 0.001 to about 0.999. In one embodiment, the mixed oxide composition exhibits a primary LnAlO₃ perovskite phase and secondary perovskite phases Ln₍₁₋ₓ₎AE_{X}TMO₃, LnAl_{(1-y)}TM_{(y)}O₃ or Ln₍₁₋ₓ₎AE₍ₓ₎Al_{(1-y)}TM_{(y)}O₃ fresh/as manufactured and after aging at 1100° C. for 10 hrs in air, where Ln is lanthanum, AE is strontium, and TM is iron, with x being about 0.001 to about 0.999 and y is from about 0.001 to about 0.999.

In one embodiment, the secondary perovskite phases can be fresh/as manufactured and/or after aging at 1100° C. for 10 hrs in air.

As the amounts of both TM and AE increase in the formulation, LaFeO₃, La₍₁₋ₓ₎Sr₍ₓ₎FeO₃ and SrFeO₃ can be present. In the formula x is the molar ratio of AE, with x being from 0.001 to 0.999.

In another embodiment, x in the mixed oxide compositions can range from 0 to 1. In one embodiment, y in the mixed oxide compositions can range from 0 to 1. In one embodiment, both x and y in the mixed oxide compositions range from 0 to 1.

Further disclosed is a dispersion or suspension comprising the mixed oxide composition as disclosed herein and a Platinum Group Metal. The addition of the PGM metals to the mixed oxide composition provides an enhanced catalyst. In certain of these embodiments, the Platinum Group Metal (PGM) can be selected from the group consisting of platinum (Pt), palladium (Pd), rhodium (Rh), iridium (Ir), ruthenium (Ru), and mixtures thereof.

As described above, the mixed oxide compositions comprise in a preferred embodiment a) about 3 to about 40 wt. % lanthanum on an oxide basis or in one embodiment from about 10 to about 40 wt. % lanthanum on an oxide basis, or in one embodiment from about 15 to about 40 wt. % lanthanum on an oxide basis; b) about 50 to about 77 wt. % aluminum on an oxide basis; c) about 0.05 wt. % to about 15.00 wt. % iron on an oxide basis or in one embodiment from about 0.05 wt. % to about 10.00 wt. % iron on an oxide basis; d) about 0.02 wt. % to about 5.00 wt. % strontium on an oxide basis or in one embodiment from about 0.02 wt. % to about 3.00 wt. % strontium on an oxide basis. In this mixed oxide composition optionally up to 99 wt. % of the lanthanum can be substituted with a different rare earth element, wherein the total amount of lanthanum and the different/optional rare earth are in an amount of about 3 to about 40 wt. % on an oxide basis. In certain embodiments this different/optional rare earth element can be selected from the group consisting of neodymium, yttrium, praseodymium, samarium, gadolinium, and mixtures thereof. In this mixed oxide composition optionally up to 99 wt. % of the iron can be substituted with any transition metal (TM) dopant, wherein the total amount of iron and the transition metal dopant when present are in an amount of about 0.05 to about 15.0 wt. % on an oxide basis. In certain embodiments the transition metal (TM) dopant is selected from the group consisting of manganese, chromium, cobalt, vanadium, copper, titanium, zinc, and mixtures thereof. In this mixed oxide composition optionally up to 99 wt. % of the strontium can be substituted with an alkaline earth (AE) metal dopant, wherein the total amount of strontium and the alkaline earth metal dopant when present are in an amount of about 0.02 to about 5.00 wt. % on an oxide basis. In certain embodiments the alkaline earth (AE) metal dopant is selected from the group consisting of magnesium, calcium, and mixtures thereof, wherein the total amount of strontium and the alkaline earth metal dopant when present are in an amount of about 0.02 to about 5.00 wt. % on an oxide basis.

In certain embodiments, the suspension contains rhodium or palladium as the Platinum Group Metal (PGM). In further specific embodiments, the impregnation comprises about 95 wt. % to about 99.5 wt % of the mixed oxide composition.

In one embodiment, the suspension comprises about 30 wt. % to about 80 wt. % of the mixed oxide composition. In one embodiment, the suspension of the mixed oxide composition and PGM comprises rhodium in an amount ranging from 0.2 wt. % to about 1.50 wt. % rhodium as metal on a mixed oxide basis. When the PGM comprises palladium, the palladium is present in the suspension in an amount that ranges from about 0.5 wt. % to about 4.0 wt. % palladium as metal on a mixed oxide basis. The suspension can further comprise pseudoboehmite in one embodiment.

The suspension can also consist essentially of a) about 3 to about 40 wt. % lanthanum on an oxide basis; b) about 50 to about 77 wt. % aluminum on an oxide basis; c) about 0.05 wt. % to about 15.00 wt. % iron on an oxide basis; d) about 0.02 wt. % to about 5.00 wt. % strontium on an oxide basis; and e) a Platinum Group Metal.

The present suspension, when dried and calcined, exhibits an improved Oxygen Storage Capacity (OSC) at about 350° C. to about 800° C., or in one embodiment at about 500° C. to 800° C., in comparison to a dried and calcined suspension containing a mixed composition with an identical composition but not containing iron and strontium.

In one embodiment, the dried and calcined suspension contains a PGM metal, which in one embodiment comprises rhodium and/or palladium.

Any of the above-described embodiments of the mixed oxide compositions may be used in a catalyst or catalyst composition as an initial feed material.

### Preparing the Mixed Oxide Compositions

The mixed oxide compositions as disclosed herein are made by methods as described in the appended Examples.

In one example, an alumina precursor (such as pseudo-boehmite) and salts of lanthanum (such as lanthanum carbonate), and any optional additional rare earth dopant salts (such as yttrium carbonate) are dissolved/dispersed in a mixture of deionized water and nitric acid. In the alternative soluble salts, such as nitrates or chlorides, can be utilized and dissolved directly in deionized water. Soluble salts of alkaline earth metals and transition metals are then added to the mixture. The mixed rare earth, alkaline earth and transition metal aluminum nitrate solution is then precipitated with a mixture of deionized water, ammonium hydroxide, and lauric acid. The pH of this step is controlled to approximately 9 to approximately 11 and then filtered. The isolated material is calcined/thermally treated at 1100° C. for about 4 hrs to about 8 hrs in air. In certain embodiments, the isolated material is calcined/thermally treated to about 1050° C. to 1150° C. or at about 1100±50° C. The calcined material can be milled to a particular particle size if desired.

Further details of the preparation of the mixed oxide compositions are described in Examples 1-7 below.

### EXAMPLES

OSC Measurements: OSC measurements were obtained under the following conditions. Powder samples were aged/heated under targeted conditions, 980° C. for 5 hrs in air. For measurement of OSC, an O₂ pulse chemisorption method was utilized with OSC measurements made at the desired temperatures. Examples include, but are not limited to, 200° C., 350° C., 450° C., 600° C., 700° C. and 800° C. For instance, for OSC measurements at 450° C., characterization was performed in a Micrometrics Autochem 2920 system, where 0.1 g of the samples were weighed into a quartz sample tube with a packed quartz wool bed. The samples were then subjected to pre-treatment in which the temperature was first raised to 450° C. under the flow of 50 cm³/min He gas, then subjected to ten-time pulse application of 10% O₂/He, followed by another twenty-time pulse application of 10% CO/He while being kept at the targeted temperature. Thereafter, the samples were subjected to pulse application of 10% O₂/He until saturation was reached and the oxygen storage capacity was measured by the cumulative quantity of O₂ absorbed at 450° C.

Compositional Content: ICP-OES (Inductively Coupled Plasma Optical Emission spectroscopy) manufactured by Agilent, Model # Agilent ICP-OES 5110 is used to provide accurate elemental analysis of the major components (e.g. Al, La, Nd, Pr, Sm, Gd, Y, Fe, Sr and optionally Si), works by introducing the sample into a high temperature plasma to ionize and excite its atoms. As the excited species return into their ground state, they emit characteristic wavelengths of light, which are then dispersed and detected to create a spectrum. This allows for the identification and quantification of elements based on their unique wavelengths. The sample is first dissolved in acid to release the elements of interest, then atomized in the atomization chamber to form a fine aerosol and introduced into a plasma rectangular tube. This causes the sample to be directly excited by the argon plasma light source for spectroscopic determination, and the results are normalized. Calibration standards help relate intensity to concentration. AAS (Atomic Absorption Spectroscopy) manufactured by Agilent, Model # Agilent AAS 200 Series AA. This technique, which is used to provide accurate elemental analysis of Fe and Sr, works by introducing the sample into a flame to convert it into a fine aerosol. Next, a hollow cathode lamp is used to emit light at wavelengths corresponding to the absorption lines of the element of interest. At specific wavelengths, the atoms absorb the emitted light, and the amount of absorbed light is measured by a detector. The sample is first dissolved in acid to release the elements of interest. Strontium oxide and iron oxide are each measured by the standard curve method using a specific lamp plugged into the atomic absorption instrument then ionized in an air-acetylene flame aspirated as the dilute sample/acid medium. The decrease in intensity is proportional to the concentration of the element in the sample.

TEM-EDS Method: For transmission electronic microscopy EDS, the instrument used was manufactured by Thermofisher, Model # Thermofisher Talos F200X TEM with Super-X SDD detector. Transmission electron microscope (TEM) uses electron beams transmitted through a thin specimen to obtain high resolution images of its internal structure. It is often coupled with EDS technique to analyze the X-ray generated when the specimen is bombarded with electrons and provide information about the elemental composition of the sample. To prepare ultra-thin specimens (typically less than 100 nm) for electron transmission, the FIB technique is used to precisely mill and remove the material at the nanoscale with a beam of focused ion (typically gallium ions). The TEM sample was prepared by focus ion beam (FIB, Thermofisher Helios G4 UX) at 30 keV, and the final FIB cleaning of TEM lamella was performed at 5 keV to minimize the surface amorphization of the thin lamella.

XRD Method: For x-ray diffraction (XRD), the following method was used. The instrument used was manufactured by Malvern Panalytical Model # Empyrean Multipurpose X-ray diffractometer. Powder sample (1-2 g) was prepared by packing and flattening (by using a glass slide) the material being analyzed on a shallow-well sample holder. X-ray diffraction (XRD) is the result of constructive interference between X-rays and a crystalline sample. The wavelength of the X-rays used is of the same order of magnitude of the distance between the atoms in a crystalline lattice. This gives rise to a diffraction pattern that can be analyzed in several ways, the most popular being applying the famous Bragg's Law (nλ=2d sin θ) which is used in the measurement of crystals and their phases. A scan speed of 0.001395°/s and a step size of 0.0393908° was employed.

BET SA using N₂ and BJH Pore Size/Radius and Pore Volume Method: This method was used to obtain BET (Brunauer, Emmett and Teller) Surface area (SA) and BJH (Barrett, Joyner, and Halenda) Pore Radius (PR) and Pore Volume (PV) data. The instrument used is the Micromeritics Model #ASAP 2460 Surface Area and Porosimetry Analyzer. To prepare a powder sample for analysis, the sample is first degassed at 350° C. for 2 hrs. The technique involves exposing the material to N, gas and measuring the amount of N₂ gas adsorbed at different pressures. The BET theory, which is applied to determine the specific surface area of the material, relates to the amount of gas adsorbed at a given pressure to the monolayer coverage of N₂ adsorbate on the surface. The BJH theory, which is applied to determine the pore volume and pore size distribution, analyzes the desorption isotherms over the range of relative pressures where the desorption occurs.

Particle Size Method: Particle sizes were measured by laser using a Malvern Mastersizer. Particle size distribution does not require wet milling, thus reducing mechanical and chemical exposure during washcoat preparation stage. Additionally, dry milling reduces chemical attacks caused by mechanical wet milling at temperatures ranging from 45° C. to 70° C.

Cyclic Lean/Rich Aging: Is a deactivation test used to evaluate performance of materials under conditions more closely related to that experienced on an engine. This aging test consists of several components: 1) Oxidative environment (Lean) e.g. Purging O₂, 2) Reductive environment (Rich) e.g. Purging CO, 3) Alternating Lean/Rich conditions e.g. pulse purging different gases, 4) Humidity e.g. Purging water vapor, 5) Subjecting the sample to high temperature over a period e.g. 1000° C. for 10 hrs in air. A laboratory Lean/Rich aging cycle as described is used consistently within the catalysis testing industry.

### Mixed Oxide Composition Examples

### Example 1: (336) 29.74% La₂O₃/70.26% Al₂O₃ (ca. 40% LaAlO₃/Al₂O₃) Manufactured Via the Impregnation Route

A 6.0 Kg batch of 30/70 La₂O₃/Al₂O₃ was made by impregnating a mixture of 6.0 Kg Lanthanum nitrate solution at 30% La₂O₃ content and 0.5 Kg Deionized Water onto 6.0 Kg Pseudo-boehmite at 70% Al₂O₃ content. The mixed solution was sprayed on the material at approximately 3.8 L/min, continuous mixing was employed throughout. The resulting final impregnated material with solid content ˜48% oxide basis was then calcined to 1100° C., 1100±50° C. range. The material was then milled to final particle size D90≤20 μm.

### Example 2: (513) Preparation of 24.30% La₂O₃/70.26% Al₂O₃/0.90% Fe₂O₃/0.16% SrO, Ca. 33% LaAlO₃/Al₂O₃ and a Secondary Perovskite Phase Manufactured Via the Impregnation Route

A 6.0 Kg batch of 24.30% La₂O₃/70.26% Al₂O₃/0.90% Fe₂O₃/0.16% SrO was made by impregnating a mixture of 5.0 Kg Lanthanum nitrate solution at 30% La₂O₃ content, 0.027 Kg Strontium nitrate (Sr(NO₃)₂) at 48.96% SrO content, 0.261 Kg Iron III nitrate (Fe(NO₃)3×9H₂O) at 19.76% Fe₂O₃ content and 0.876 Kg deionized water onto 6.34 Kg pseudoboehmite at 70% oxide content. The mixed solution was sprayed on to the pseudoboehmite at approximately 3.8 L/min, continuous mixing was employed throughout. The resulting final impregnated material with solid content ˜48% oxide basis was then calcined to 1100° C., 1100±50° C. range. The material was then milled to final particle size D90≤20 μm.

### Example 3: (569) Preparation of 25.02% La₂O₃/71.13% Al₂O₃/3.40% Fe₂O₃/0.45% SrO, Ca. 33% LaAlO₃/Al₂O₃ and a Secondary Perovskite Phase Manufactured Via Modified Co-Precipitation Route as an Alternate Process to Impregnation Route

A 6.0 Kg batch of 25.02% La₂O₃/71.13% Al₂O₃/3.40% Fe₂O₃/0.45% SrO was made by first dispersing 7.0 Kg of pseudoboehmite in 30 L of a 0.5M (ca. 3% HNO₃) nitric acid solution to which a mixture of 5.0 Kg Lanthanum nitrate solution at 30% La₂O₃ content, 0.110 Kg Strontium nitrate (Sr(NO₃)₂) at 48.96% SrO content, 1.043 Kg Iron III nitrate (Fe(NO₃)₃×9H₂O) added to 20 L deionized water is added. The final resulting mixed solution is then mixed for a minimum of 20 minutes to fully dissolve/disperse. The mixture is then precipitated with a mixture of 35 L deionized water, 3 Kg C₁₂H₂₄O₂ (Lauric acid and 5 L 9.5N NH₄OH (Ammonium hydroxide, 25% NH₃ water) with final pH controlled between 9.5 and 10.0 with mixing employed throughout. The final precipitate is then filtered, washed and calcined to 1100° C., 1100±50° C. range. The material is then milled to final particle size D90≤20 μm.

### Example 4: (653) Preparation of 19.74% La₂O₃/71.83% Al₂O₃/6.76% Fe₂O₃/1.67% SrO, Ca. 25% LaAlO₃/Al₂O₃ and a Secondary Perovskite Phase Made Via the Impregnation Route

A 6.0 Kg batch of 19.74/1.67/6.76/71.83, La₂O₃/SrO/Fe₂O₃Al₂O₃ was made by impregnating a mixture of 4.0 Kg Lanthanum nitrate solution at 30% La₂O₃ content, 0.368 Kg Strontium nitrate (Sr(NO₃)₂) at 48.96% SrO content, 2.086 Kg Iron III nitrate (Fe(NO₃)3×9H₂O) and 0.876 Kg deionized water onto 6.944 Kg Pseudo-boehmite at 70% oxide content. The mixed solution was sprayed on to the pseudo-boehmite at approximately 3.8 L/min, continuous mixing was employed throughout. The resulting final impregnated material with solid content ˜48% oxide basis was then calcined to 1100° C., 1100±50° C. range. The material was then milled to final particle size D90≤20 μm.

### Example 5 (631): Preparation of 20.11% La₂O₃/71.54% Al₂O₃/7.11% Fe₂O₃/1.24% SrO, Ca. 25% LaAlO₃/Al₂O₃ and a Secondary Perovskite Phase Via Modified Co-Precipitation as an Alternate Process to the Impregnation Route

A 6.0 Kg batch of 20.11/1.24/7.11/71.54, La₂O₃/SrO/Fe₂O₃Al₂O₃ was made by first dispersing 6.994 Kg pseudo-boehmite in 30 L of a 0.5M (ca. 3% HNO₃) nitric acid solution to which a mixture of 4.0 Kg Lanthanum nitrate solution at 30% La₂O₃ content, 0.368 Kg Strontium nitrate (Sr(NO₃)₂) at 48.96% SrO content, 2.086 Kg Iron III nitrate (Fe(NO₃)3×9H₂O) added to 20 L deionized water is added. The final resulting mixed solution this then mixed for a minimum of 20 minutes to fully dissolve/disperse. The mixture is then precipitated with a mixture of 35 L deionized water, 3 Kg C₁₂H₂₄O₂ (Lauric acid and 5 L 9.5N NH₄OH (Ammonium hydroxide, 25% NH₃ water) with final pH controlled between 9.5 and 10.0 with mixing employed throughout. The final precipitate is then filtered, washed and calcined to 1100° C., 1100±50° C. range. The material is then milled to final particle size D90≤20 μm.

### Example 6 (615): Preparation of 31.64% La₂O₃/59.86% Al₂O₃/7.39% Fe₂O₃/1.11% SrO, Ca. 40% LaAlO₃/Al₂O₃ and a Secondary Perovskite Phase Via Modified Co-Precipitation as an Alternate Process to the Impregnation Route

A 6.0 Kg batch of 31.64/1.11/7.39/59.86, La₂O₃/SrO/Fe₂O₃/Al₂O₃ was made by first dispersing 5.953 Kg of pseudo-boehmite in 30 L of a 0.5M (ca. 3% HNO₃) nitric acid solution to which a mixture of 6.0 Kg Lanthanum nitrate solution at 30% La₂O₃ content, 0.363 Kg Strontium nitrate (Sr(NO₃)₂) at 48.96% SrO content, 2.086 Kg Iron III nitrate (Fe(NO₃)3×9H₂O) added to 20 L deionized water is added. The final resulting mixed solution this then mixed for a minimum of 20 minutes to fully dissolve/disperse. The mixture is then precipitated with a mixture of 35 L deionized water, 3 Kg C₁₂H₂₄O₂ (Lauric acid and 5 L 9.5N NH₄OH (Ammonium hydroxide, 25% NH₃ water) with final pH controlled between 9.5 and 10.0 with mixing employed throughout. The final precipitate is then filtered, washed and calcined to 1100° C., 1100±50° C. range. The material is then milled to final particle size D90≤20 μm.

### Example 7 (632): Preparation of 15.13% La₂O₃/72.20% Al₂O₃/9.75% Fe₂O₃/2.92% SrO, Ca. 20% LaAlO₃/Al₂O₃ and a Secondary Perovskite Phase Via Modified Co-Precipitation as an Alternate Process to the Impregnation Route

A 6.0 Kg batch of 15.13/2.92/9.75/72.20, La₂O₃/SiO₂/SrO/Fe₂O₃/Al₂O₃ was made by first dispersing 7.011 Kg of pseudo-boehmite in 30 L of a 0.5M (ca. 3% HNO₃) nitric acid solution to which a mixture of 3.000 Kg Lanthanum nitrate solution at 30% La₂O₃ content, 0.477 Kg Strontium nitrate (Sr(NO₃)₂) at 48.96% SrO content, 3.128 Kg Iron III nitrate (Fe(NO₃)3×9H₂O) added to 20 L deionized water is added. The final resulting mixed solution this then mixed for a minimum of 20 minutes to fully dissolve/disperse. The mixture is then precipitated with a mixture of 35 L deionized water, 3 Kg C₁₂H₂₄O₂ (Lauric acid and 5 L 9.5N NH₄OH (Ammonium hydroxide, 25% NH₃ water) with final pH controlled between 9.5 and 10.0 with mixing employed throughout. The final precipitate is then filtered, washed and calcined to 1100° C., 1100±50° C. range. The material is then milled to final particle size D90≤20 μm.

Process flexibility is evident in the processes that can be used to prepare the present mixed oxide compositions. The process preparation methods can include, for example: 1) Impregnation of the mixed aqueous salt solution, the alumina support material can be aluminum trihydrate, pseudo-boehmite, gamma alumina, delta alumina, theta alumina and all other potential polymorphs which could act as a support material. 2) Coprecipitation of the mixed aqueous salt solution and alumina precursor, with alumina precursor being aluminum trihydrate, pseudo-boehmite or aluminum nitrate. 3) Spray or spin flash drying a slurry comprised of a mixture of water-soluble salts, an alumina precursor, aluminum trihydrate, rho alumina and pseudo-boehmite being preferred. Calcination of the impregnated or dried product can be performed using commercially available trays, rotary kiln, fluidized bed calciner or any other commercially available means to dry and calcine product. Pore formers can also be added to any process option, they can include nanosized polymeric organic materials, carboxylic acids, aliphatic hydrocarbons with various functional groups, cyclic hydrocarbons with various functional groups, activated carbon, graphite, carbohydrates, starches, urethanes, esters, carbamic acid, primary, secondary tertiary, and quaternary amines, etc. Each organic pore former can be considered what is known in the art as a template to create specific pore size distributions, shapes and total porosity of the resulting calcined product. Calcination of the intermediate filter cake, dried product occurs at 1100±50° C. in air such that all organic materials are removed during calcination. Total organic load, functional groups and salt type (chloride, nitrate, sulfate) are all considered when it comes to safe operation.

### Example 8: Characterization of LaAlO₃ Loading to Determine Optimum Composition

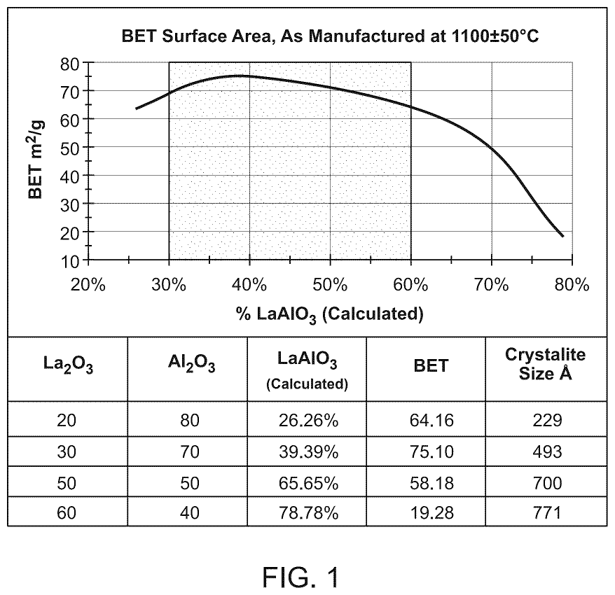

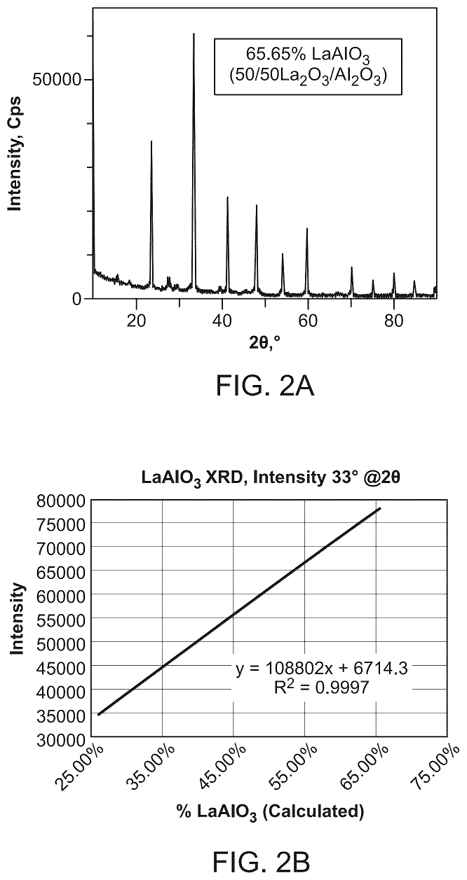

Loadings between 20-60 wt % La₂O₃ were studied. FIG. 1 graphically demonstrates optimum LaAlO₃ concentration as between 30-60 wt. %. LaAlO₃ content was calculated by analyzing the Lanthanum content by ICP and verifying the presence of LaAlO₃ by XRD. Manufacturing calcination temperature for all samples was 1100±50° C., they were then analyzed by XRD on an “as-is”/fresh basis to confirm presence of the targeted perovskite phases, the BET surface area was also measured for the “as-is”/as-prepared compositions (i.e., fresh) material. The results are shown in FIG. 1 as discussed above, and in FIGS. 2A and 2B.

FIG. 2A is an XRD diffractogram demonstrating LaAlO₃ as the primary phase as manufactured/calcined at 1100±50° C. FIG. 2B demonstrates linearity based on intensity measurements at the primary peak located at 33°, 2q for calculated LaAlO₃ content between ˜25 wt. % to 65 wt. %. The primary peak at 33°, 2q is a major focal point of this invention however, the secondary peak located at 23°@2q may be referenced.

### Example 9: Characterization of LaAlO₃ and LaAl_{(1-y)}Fe_{y}O₃ Mixed Oxide System

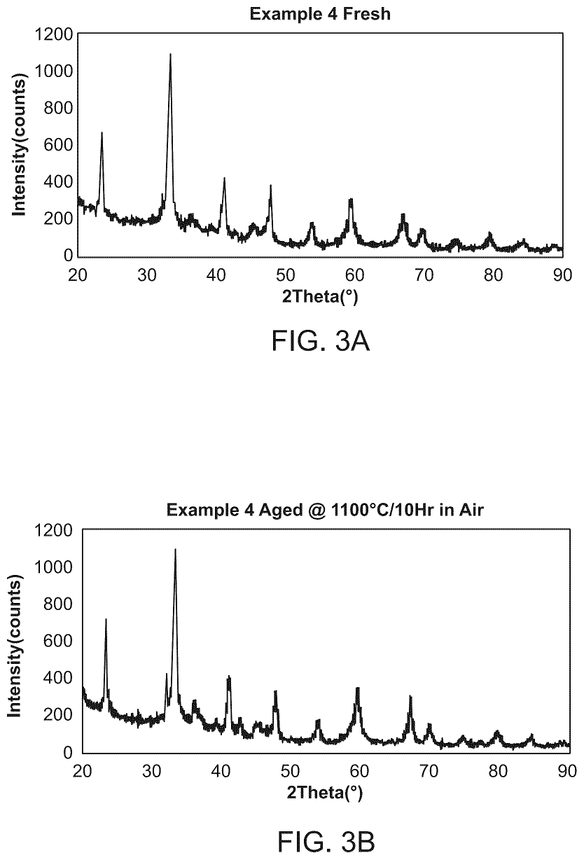

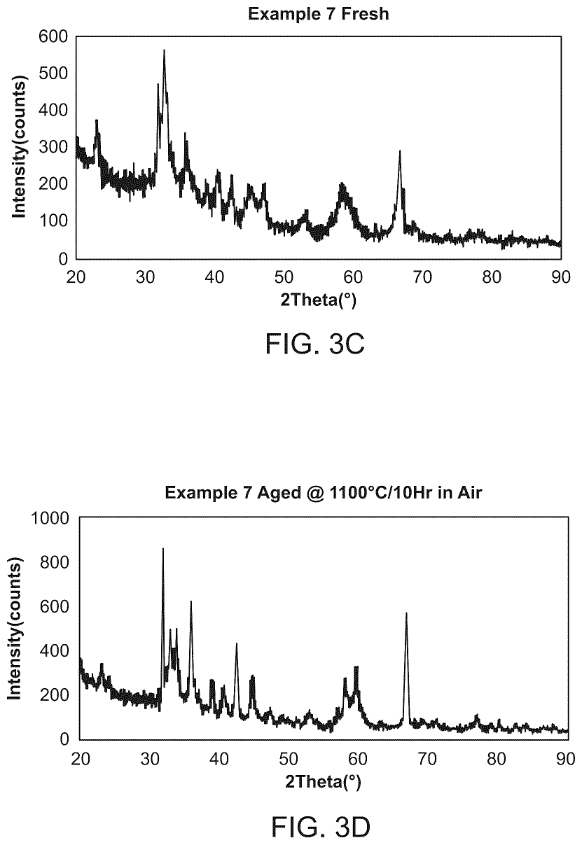

Mixed oxides of Examples 4 and 7 were subjected to XRD and the patterns showed a primary phase and a secondary phase. This is shown in FIGS. 3A-3D. FIGS. 3A-3D show XRD diffractograms demonstrating LaAlO₃ as the primary phase and LaAl_{(1-y)}Fe_{y}O₃ as a secondary phase, with y the molar ratio of Fe. Examples 4 and 7 were also manufactured/calcined at 1100±50° C. FIGS. 3A/3B, and 3C/3D include comparisons of the mixed oxides of Experiments 4 and 7, fresh and after aging at 1100° C. for 10 hrs in air. As described above, the secondary perovskite can be of the formulae, Ln₍₁₋ₓ₎AE_{X}TMO₃, LnAl_{(1-y)}TM_{(y)}O₃ or Ln₍₁₋ₓ₎AE₍ₓ₎Al_{(1-y)}TM_{(y)}O₃, with x the molar ratio of AE and y the molar ratio of TM.

### Example 10: Iron and Sr Insertion in LaAlO₃, Primary x-Ray Diffraction (XRD) Peak at 33°, 2θ and Secondary Diffraction Peak at 23°, 2θ Based on the Mixed Oxide of Example 7

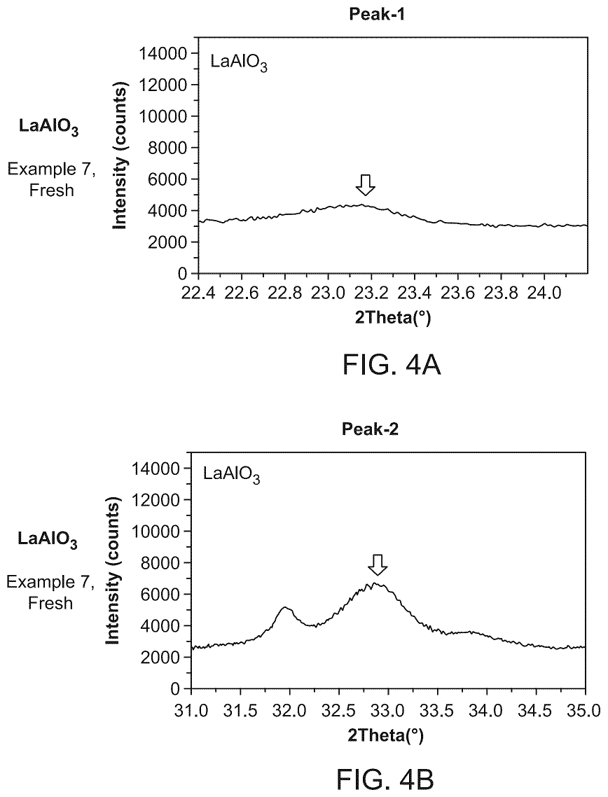

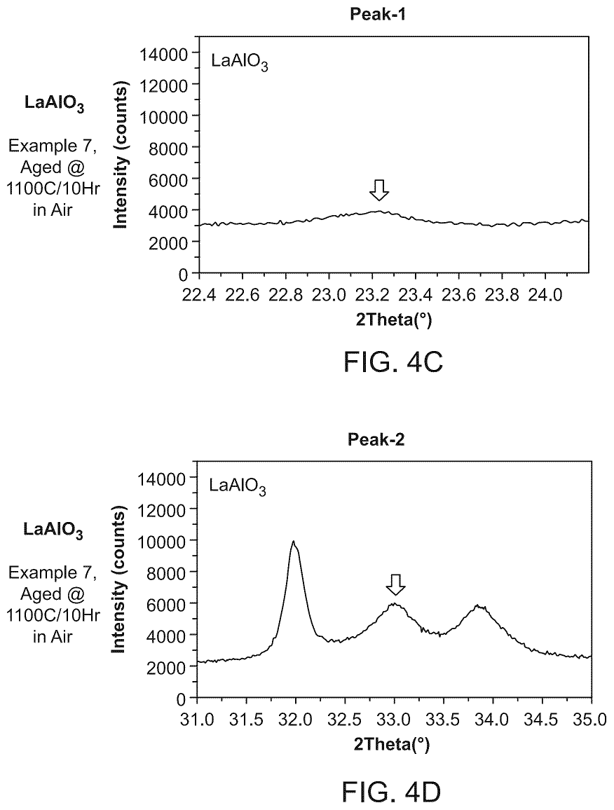

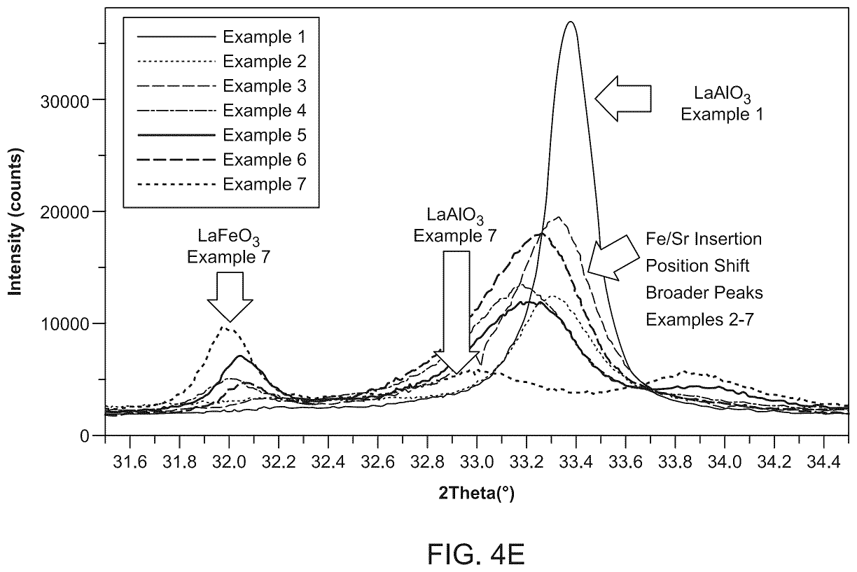

The diffractograms of FIG. 4A and FIG. 4B demonstrate location of the primary and secondary peaks which identify the primary perovskite as LaAlO₃. For this invention, the primary peak at 33°, 2q is the focus. The diffractograms of FIG. 4C and FIG. 4D demonstrate the transformation of LaAlO₃ primary peak position at 33°, 2q. Using the formula, LaAl_{(1-y)}Fe_{y}O₃ diffraction peaks at 2q typically fall between 32° to 34°, with the exact position shifting based on Fe concentration. For pure LaAlO₃, y=0 in the formula specified above. When the value of y changes y=1, the formula becomes LaFeO₃, with a characteristic primary peak forming ˜32° 2q. For the solid solution of LaAl_{(1-y)}Fe_{y}O₃, the primary peak position shifts closer to 32° as the amount of Fe in the examples increases with Example 7 being the highest.

FIG. 4E demonstrates insertion, peak broadening, peak location shifting to a lower angle when measured at 2θ, and formation of both transitional secondary perovskites and the formation of LaFeO₃.

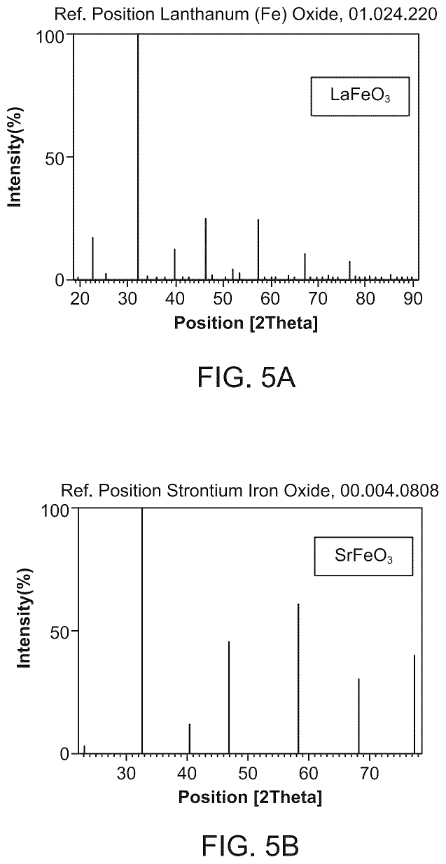

FIGS. 5A and 5B are additional reference XRD diffractograms for LaAlO₃ (primary perovskite. LaFeO₃ (FIG. 5A) and SrFeO₃ (FIG. 5B) are secondary perovskites which have a primary diffraction peak between 32°-33°, 2q.

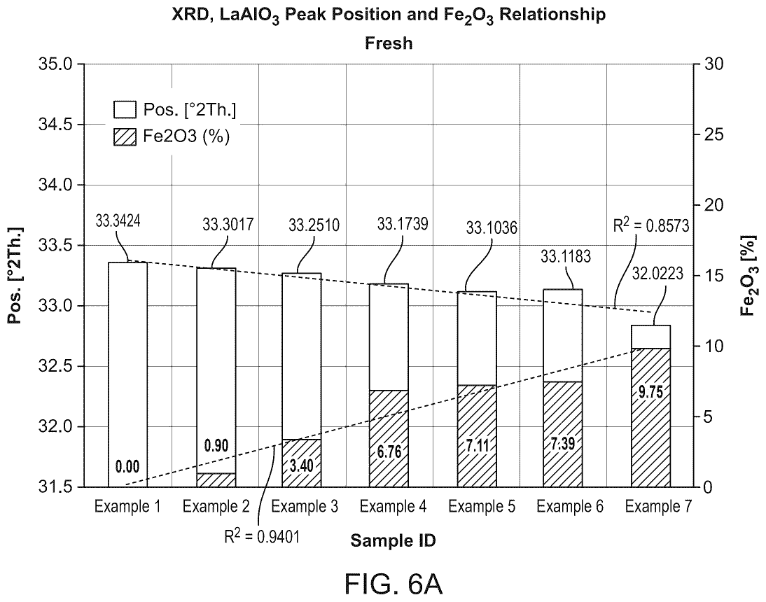

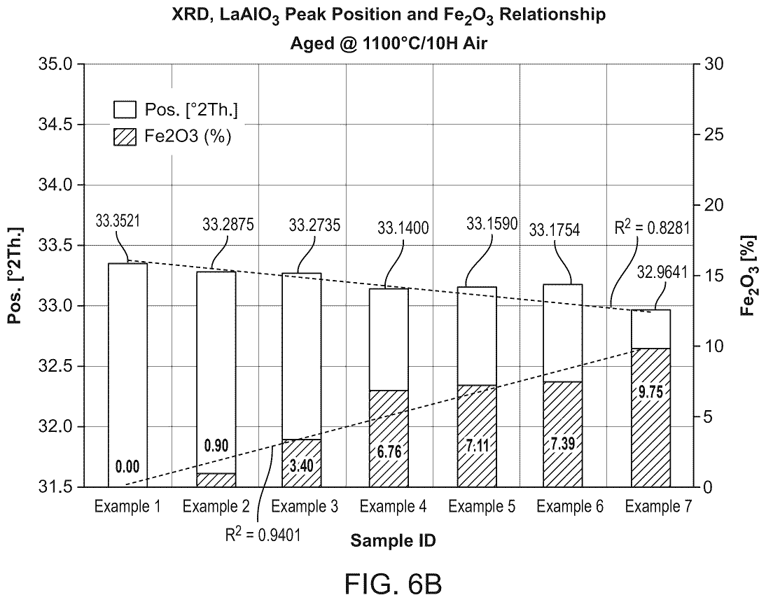

Turning to FIG. 6A and FIG. 6B, the graphs are based on information from the mixed oxides of Examples 1-7. The graphs demonstrate how the LaAlO₃ peak position shifts as Fe and Sr insert into the lattice. FIG. 6A shows this for LaAlO₃ fresh and FIG. 6B shows this for aging at 1100° C. for 10 hrs in air. The XRD data for FIG. 6A is in Table 1 below, and the XRD data for FIG. 6B is in Table 2 below.

As both Fe and Sr insert into the lattice of LaAlO₃, the peak at 33°, 2q shifts to a smaller angle when measured at 2q, example 1 at 33.3° to example 7 at 32.9° as [Fe₂O₃] increases from zero to 9.75 wt. %.

TABLE 1

XRD Data
Fresh

| Sample ID | Fe₂O₃ (%) | Pos. [*2Th.] | d-spacing[Å] |
|---|---|---|---|
| Example 1 | 0.00 | 33.3424 | 2.68510 |
| Example 2 | 0.90 | 33.3017 | 2.68829 |
| Example 3 | 3.40 | 33.2510 | 2.69227 |
| Example 4 | 6.76 | 33.1739 | 2.69836 |
| Example 5 | 7.11 | 33.1036 | 2.70392 |
| Example 6 | 7.39 | 33.1183 | 2.70275 |
| Example 7 | 9.75 | 32.8323 | 2.72564 |

TABLE 2

XRD Data
Aged 1100° C. for 10 hrs in Air

| Sample ID | Fe₂O₃ (%) | Pos. [*2Th.] | d-spacing[Å] |
|---|---|---|---|
| Example 1 | 0.00 | 33.3521 | 2.68510 |
| Example 2 | 0.90 | 33.2875 | 2.68829 |
| Example 3 | 3.40 | 33.2735 | 2.69227 |
| Example 4 | 6.76 | 33.1400 | 2.69836 |
| Example 5 | 7.11 | 33.1590 | 2.70392 |
| Example 6 | 7.39 | 33.1754 | 2.70275 |
| Example 7 | 9.75 | 32.9641 | 2.72564 |

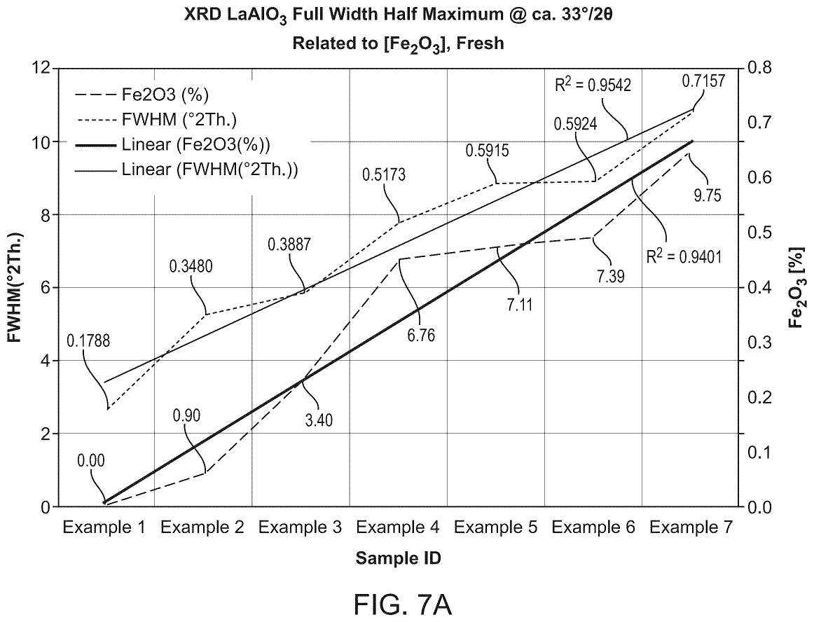

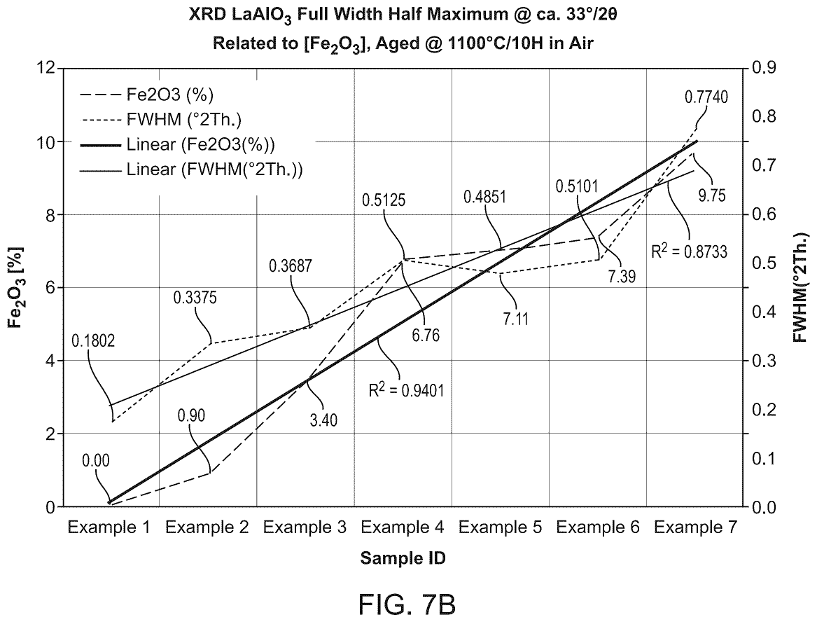

FIG. 7A and FIG. 7B show full width at half maximum peak height (FWHM), a measurement of lattice strain/expansion as Fe and Sr insert. The results plotted in FIGS. 7A and 7B both support insertion of Fe and Sr into the LaAlO₃ lattice. Peak broadening is evident, with the slightly larger ionic radius of Fe (+2, +3 and +4) and Sr (+2) relative to Al+3. The XRD data for FIG. 7A is in Table 3 below, and the XRD data for FIG. 7B is in Table 4 below.

TABLE 3

| | XRD Data | | | |
|---|---|---|---|---|
| | Fresh | | | |
| Sample ID | Fe₂O₃ (%) | Pos. [*2Th.] | FWHM (*2Th.) | d-spacing[Å] |
| Example 1 | 0.00 | 33.3424 | 0.1788 | 2.68510 |
| Example 2 | 0.90 | 33.3017 | 0.3480 | 2.68829 |
| Example 3 | 3.40 | 33.2510 | 0.3887 | 2.69227 |
| Example 4 | 6.76 | 33.1739 | 0.5173 | 2.69836 |
| Example 5 | 7.11 | 33.1036 | 0.5915 | 2.70392 |
| Example 6 | 7.39 | 33.1183 | 0.5924 | 2.70275 |
| Example 7 | 9.75 | 32.8323 | 0.7157 | 2.72564 |

TABLE 4

| | XRD Data | | | |
|---|---|---|---|---|
| | Aged 1100° C. for 10 hrs in Air | | | |
| Sample ID | Fe₂O₃ (%) | Pos. [*2Th.] | FWHM (*2Th.) | d-spacing[Å] |
| Example 1 | 0.00 | 33.3521 | 0.1802 | 2.68434 |
| Example 2 | 0.90 | 33.2875 | 0.3375 | 2.68940 |
| Example 3 | 3.40 | 33.2735 | 0.3687 | 2.69050 |
| Example 4 | 6.76 | 33.1400 | 0.5125 | 2.70104 |
| Example 5 | 7.11 | 33.1590 | 0.4851 | 2.69953 |
| Example 6 | 7.39 | 33.1754 | 0.5101 | 2.69824 |
| Example 7 | 9.75 | 32.9641 | 0.7740 | 2.71505 |

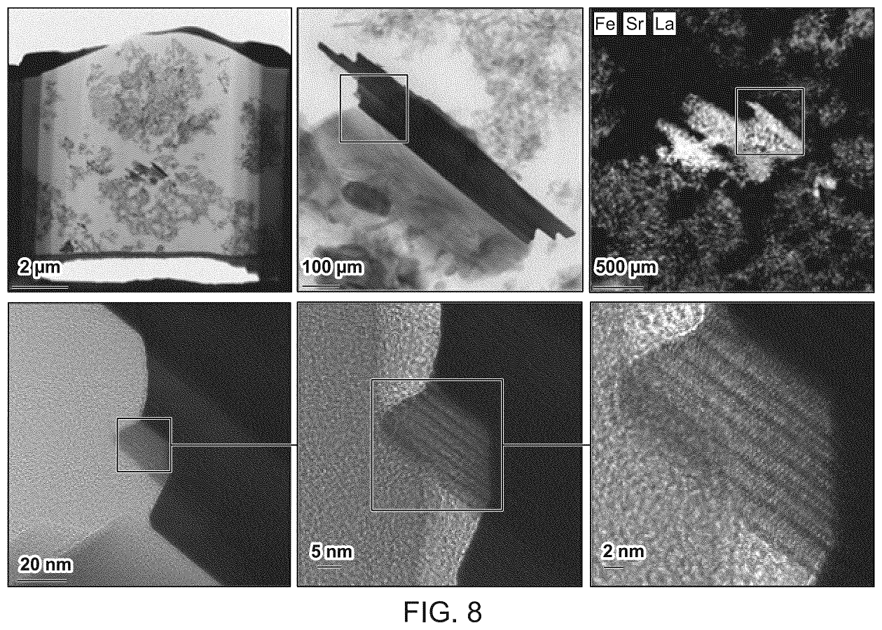

Turning to FIG. 8, TEM/EDS photomicrographs are shown demonstrating large crystal LaAlO₃, with incorporation of Fe to form LaFeO₃ and/or intermediate phases. Other regions indicate strong co-localization of Fe and Sr, suggesting these elements are well mixed and formed a homogeneous phase, i.e., SrFeO₃. Certain regions support formation of the perovskite phases Ln₍₁₋ₓ₎AE_{X}TMO₃, LnAl_{(1-y)}TM_{(y)}O₃ and/or Ln₍₁₋ₓ₎AE₍ₓ₎Al_{(1-y)}TM_{(y)}O₃. One phase represents large crystal LaAlO₃, with some incorporation of Fe to form LaFeO₃ and/or intermediate phases. Other regions indicate strong co-localization of Fe and Sr, suggesting that these elements are well mixed and forming a homogeneous phase, i.e., SrFeO₃. These TEM/EDS Photomicrographs support the XRD findings.

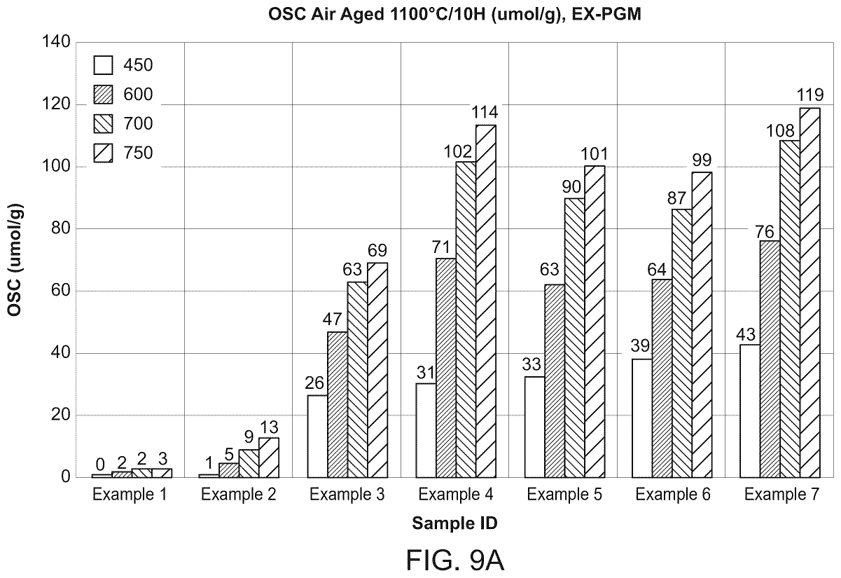

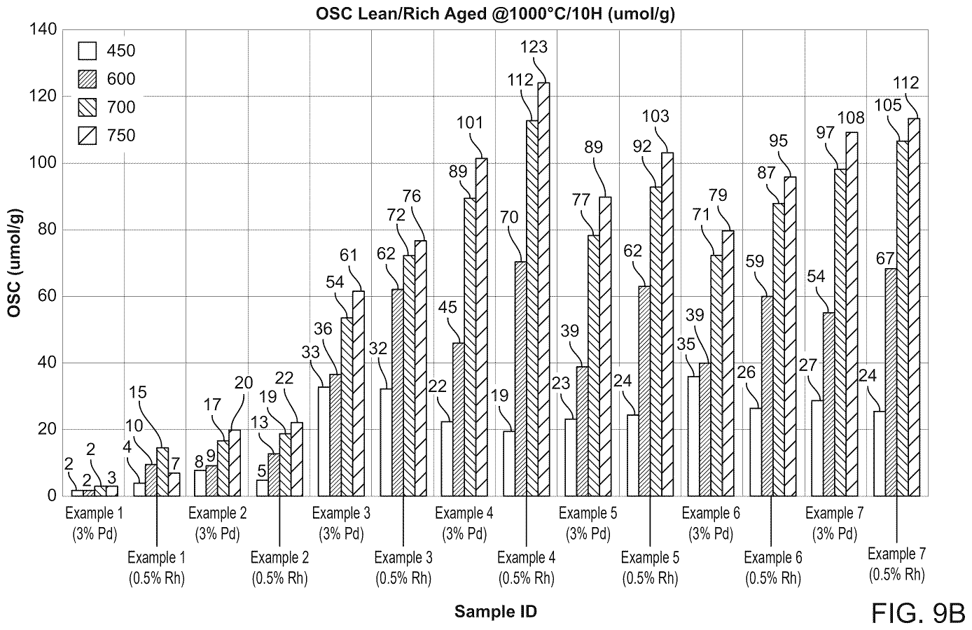

FIG. 9A and FIG. 9B are graphs, and Tables 5 and 6 below demonstrate the relative improvement the combination of primary and secondary perovskite phases has on OSC when measured at 450° C., 600° C., 700° C. and 750° C. post 1100° C. for 10 hrs air (FIG. 9A) and 1000° C. for 10 hrs in air Lean/Rich aging (FIG. 9B). Example 1 contains only LaAlO₃.

FIG. 9A represents mixed oxides only, no PGM added. From the data in Table 5 one can see that Example 4-Example 7 create a robust OSC region. One can see from the data, depending on Fe and Sr concentration and temperature where OSC is measured after the samples have been aged at 1100° C. for 10 hrs in air, ˜10 times to 90 times improvement of OSC has been realized when compared to Example 1 which does not contain any Fe or Sr.

FIG. 9B represents the mixed oxides of Example 1 through Example 7 each tested two ways, one way with 3 wt. % Palladium (Pd) added and the second way 0.5% Rhodium (Rh) added. Aging here was at 1000° C. for 10 hrs in air Lean/Rich cycling. The trend noted was the same as FIG. 9A, the data for FIG. 9B is in Table 6 below.

TABLE 5

| | | | | | OSC Aged 1100° C. | | | | | | | |
|---|---|---|---|---|---|---|---|---|---|---|---|---|
| | | | | | for 10 hrs in Air | | | | OSC Aged 1100° C. for 10 hrs in | | | |
| | | | | | L/R. (μmol/g) | | | | Air L/R. (μmol/g) | | | |
| Sample | Chemical Composition (ICP) | | | | Temperature ° C. | | | | Temperature ° C. (% Improved) | | | |
| ID | La₂O₃ | Al₂O₃ | Fe₂O₃ | SrO | 450 | 600 | 700 | 750 | 450 | 600 | 700 | 750 |
| Example 1 | 29.74% | 70.26% | 0.0% | 0.0% | 0 | 2 | 2 | 3 | 0% | 0% | 0% | 0% |
| Example 2 | 24.30% | 74.64% | 0.90% | 0.16% | 1 | 5 | 9 | 13 | 9% | 133% | 292% | 363% |
| Example 3 | 25.02% | 71.13% | 3.40% | 0.45% | 26 | 47 | 63 | 69 | 5199% | 2184% | 2607% | 2344% |
| Example 4 | 19.74% | 71.83% | 6.76% | 1.67% | 31 | 71 | 102 | 114 | 6038% | 3381% | 4305% | 3905% |
| Example 5 | 20.11% | 71.54% | 7.11% | 1.24% | 33 | 63 | 90 | 101 | 6453% | 2972% | 3793% | 3461% |
| Example 6 | 31.64% | 59.86% | 7.39% | 1.11% | 39 | 64 | 87 | 99 | 7676% | 3028% | 3651% | 3391% |
| Example 7 | 15.13% | 72.20% | 9.75% | 2.92% | 43 | 76 | 108 | 119 | 8566% | 3632% | 4574% | 4104% |

TABLE 6

| | Chemical | | | | | | | |
|---|---|---|---|---|---|---|---|---|
| | Composition | | | | % Increase | | | |
| | (ICP) | | | | Relative to Example 1 | | | |
| Sample ID | 450 | 600 | 700 | 750 | 450 | 600 | 700 | 750 |
| Example 1 | 2 | 2 | 3 | 3 | 0% | 0% | 0% | 0% |
| (3% Pd) | | | | | | | | |
| Example 1 | 4 | 10 | 15 | 7 | 123% | 334% | 337% | 104% |
| (0.5% Rh) | | | | | | | | |
| Example 2 | 8 | 9 | 17 | 20 | 301% | 315% | 403% | 465% |
| (3% Pd) | | | | | | | | |
| Example 2 | 5 | 13 | 19 | 22 | 133% | 467% | 467% | 530% |
| (0.5% Rh) | | | | | | | | |
| Example 3 | 33 | 36 | 54 | 61 | 1529% | 1523% | 1494% | 1657% |
| (3% Pd) | | | | | | | | |
| Example 3 | 32 | 62 | 72 | 76 | 1485% | 2668% | 2032% | 2083% |
| (0.5% Rh) | | | | | | | | |
| Example 4 | 22 | 45 | 89 | 101 | 1006% | 1935% | 2527% | 2800% |
| (3% Pd) | | | | | | | | |
| Example 4 | 19 | 70 | 112 | 123 | 836% | 3029% | 3217% | 3432% |
| (0.5% Rh) | | | | | | | | |
| Example 5 | 23 | 39 | 77 | 89 | 1035% | 1643% | 2187% | 2459% |
| (3% Pd) | | | | | | | | |
| Example 5 | 24 | 62 | 92 | 103 | 1083% | 2707% | 2636% | 2841% |
| (0.5% Rh) | | | | | | | | |
| Example 6 | 35 | 39 | 71 | 79 | 1629% | 1666% | 2014% | 2153% |
| (3% Pd) | | | | | | | | |
| Example 6 | 26 | 59 | 87 | 95 | 1181% | 2540% | 2467% | 2618% |
| (0.5% Rh) | | | | | | | | |
| Example 7 | 27 | 54 | 97 | 108 | 1270% | 2327% | 2775% | 2999% |
| (3% Pd) | | | | | | | | |
| Example 7 | 24 | 67 | 105 | 112 | 1094% | 2931% | 3023% | 3117% |
| (0.5% Rh) | | | | | | | | |

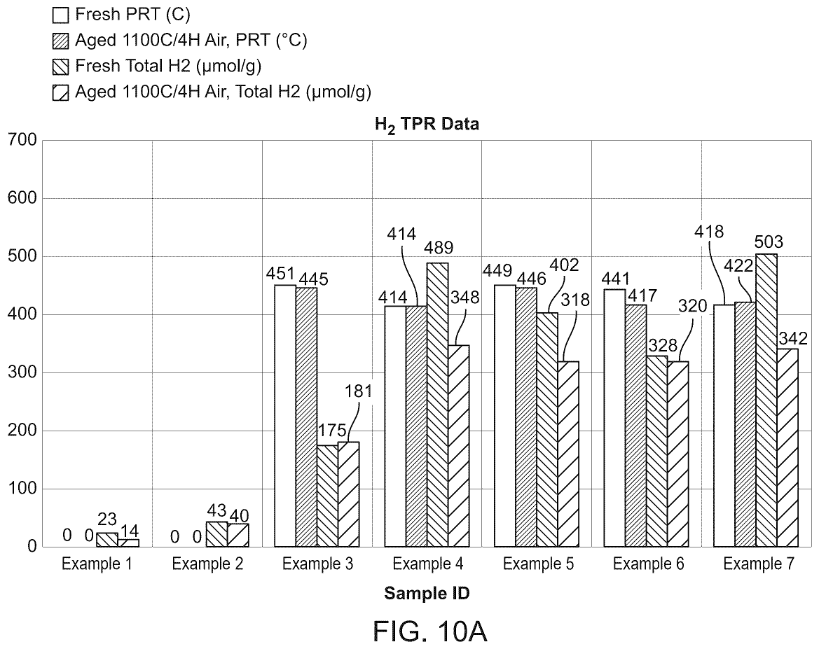

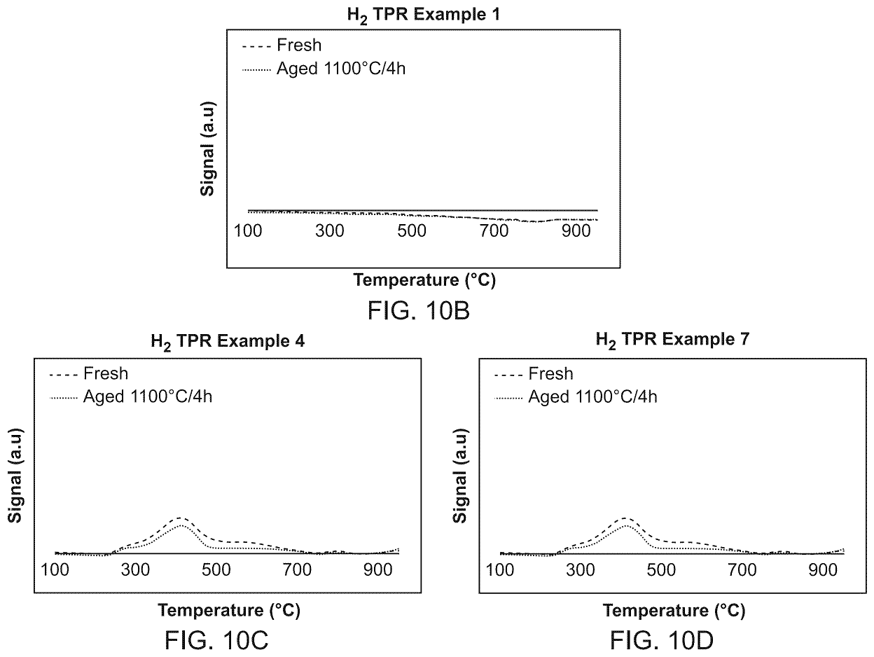

FIGS. 10A-10D show H₂-TPR, Temperature Programmed Reduction (TPR).

FIG. 10A represents a comparison of Examples 1-7 Peak Reduction Temperature (PRT) and mmol/g H₂ consumed. Lower PRT (° C.) corresponds to a material that is reduced at lower temperature, meaning it is more active catalytically. Higher Total H₂ (mmol/g) relates directly to the materials oxygen storage capacity (OSC). The data trend supports the results shown in FIGS. 9A and 9B. Example 4 is shown to have the lowest PRT and highest mmol/g total H₂ (OSC). The data for FIG. 10A is given in Table 7 below.

FIGS. 10B-10D are the actual TPR curves for Experiment 1 (no Fe/Sr) and Experiments 4 and 7.

TABLE 7

| | H₂ TPR Data Table, Total H₂ (OSC) | | | |
|---|---|---|---|---|
| | and Peak Reduction Temperature (PRT) | | | |
| | Fresh | Aged 1100° C. | Fresh | Aged 1100° C. |
| | PRT | for 4 hrs in Air, | Total H₂ | for 4 hrs in Air, |
| Sample ID | (C.) | PRT (° C.) | (μmol/g) | Total H₂ (μmol/g) |
| Example 1 | 0 | 0 | 23 | 14 |
| Example 2 | 0 | 0 | 43 | 40 |
| Example 3 | 451 | 445 | 175 | 181 |
| Example 4 | 414 | 414 | 489 | 348 |
| Example 5 | 449 | 446 | 402 | 318 |
| Example 6 | 441 | 417 | 328 | 320 |
| Example 7 | 418 | 422 | 503 | 342 |

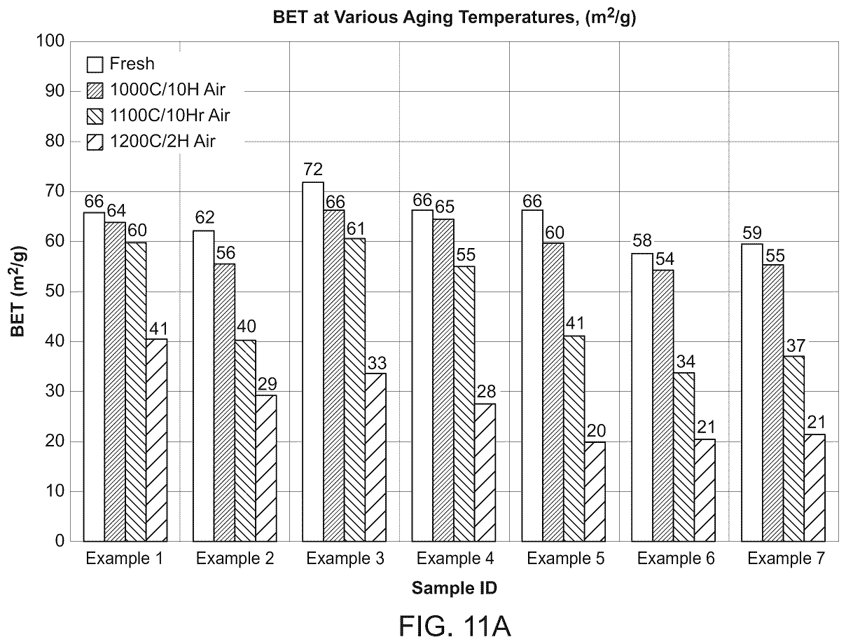

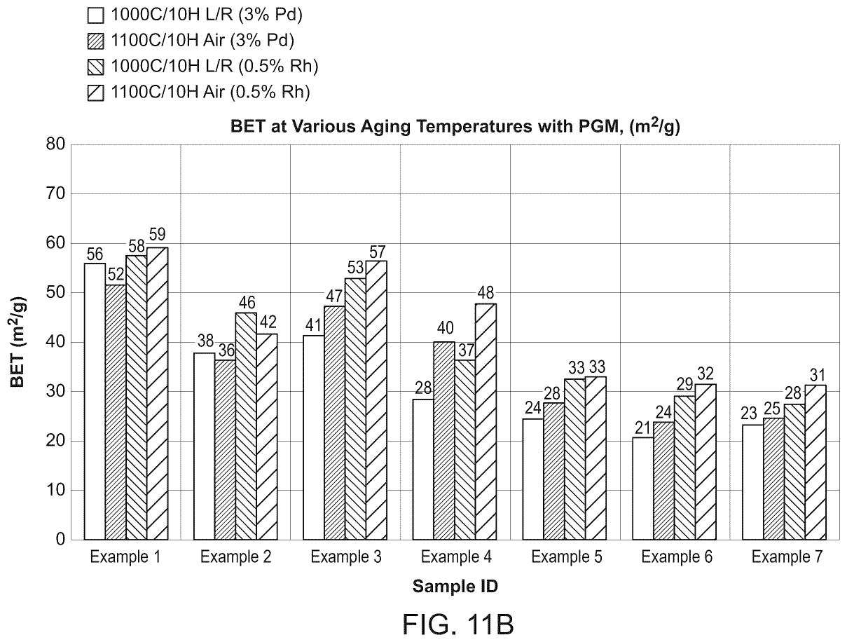

FIG. 11A and FIG. 11B show a BET surface area stability comparison of Examples 1-7 at different aging temperatures and conditions.

FIG. 11A shows the BET surface area of Examples 1-7 at various aging temperatures in air without PGM. The data, given in Table 8 below, demonstrates that as Fe and Sr levels increase, the BET surface area decreases. This effect is supported by the formation of LaFeO₃ and SrFeO₃ which are highly crystalline materials and act as seeds/sintering aids. Examples 1˜4 are the most thermally stable.

TABLE 8

| | BET (m2/g) | | | |
|---|---|---|---|---|
| | Temperature ° C. | | | |
| | | 1000° C. for | 1100° C. for | 1200° C. for |
| Sample ID | Fresh | 10 hrs in Air | 10 hrs in Air | 2 hrs in Air |
| Example 1 | 66 | 64 | 60 | 41 |
| Example 2 | 62 | 56 | 40 | 29 |
| Example 3 | 72 | 66 | 61 | 33 |
| Example 4 | 66 | 65 | 55 | 28 |
| Example 5 | 66 | 60 | 41 | 20 |
| Example 6 | 58 | 54 | 34 | 21 |
| Example 7 | 59 | 55 | 37 | 21 |

FIG. 11B shows BET surface area stability of Examples 1-7 comparing 1000° C. for 10 hrs in air Lean/Rich (L/R) aging to 1100° C. for 10 hrs aging in air. The data is given in Table 9 below. In this case, the comparison also includes 3% Pd and 0.5% Rh. From the results, Rh samples are more stable than Pd, with Examples 1-4 demonstrating the least amount of decay. L/R aging is more severe and more closely represents conditions catalysts and catalytic materials are exposed to in an actual gasoline internal combustion engine. The sintering mechanism is believed to be related to FIG. 11A, with increased Fe/Sr increasing the sintering rate of the material, L/R aging accelerates that effect. Note also that Example 3 is co-precipitated, this provides enhancements in thermal stability and pore integrity.

TABLE 9

| | BET (m2/g) | | | |
|---|---|---|---|---|
| | Temperature ° C. | | | |
| | 1000° C. for | | 1000° C. for | |
| | 10 hrs in | 1100° C. for | 10 hrs in | 1100° C. for |
| | Air L/R | 10 hrs in Air | Air L/R | 10 hrs in Air |
| Sample ID | (3% Pd) | (3% Pd) | (0.5% Rh) | (0.5% Rh) |
| Example 1 | 56 | 52 | 58 | 59 |
| Example 2 | 38 | 36 | 46 | 42 |
| Example 3 | 41 | 47 | 53 | 57 |
| Example 4 | 28 | 40 | 37 | 48 |
| Example 5 | 24 | 28 | 33 | 33 |
| Example 6 | 21 | 24 | 29 | 32 |
| Example 7 | 23 | 25 | 28 | 31 |

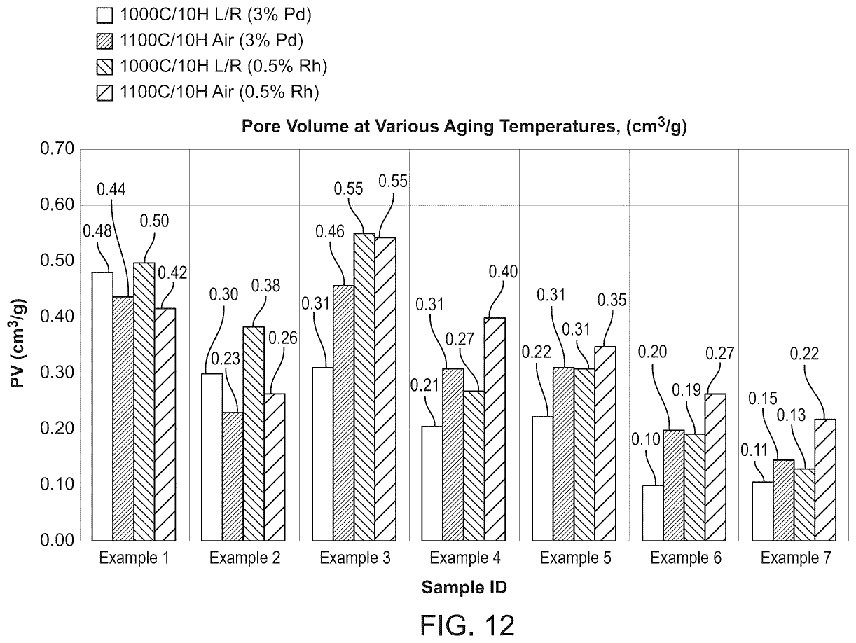

FIG. 12 demonstrates pore volume measurements of the mixed oxides of Examples 1-7. Sintering effects are most noted as Fe/Sr increase, i.e., pore volume decreases with increased Fe/Sr. The positive effect of the co-precipitation process is also noted here with Example 3. Examples 2 and 4 were made via the impregnation process and have comparable aging profiles whereas Examples 5, 6 and 7 were made via the co-precipitation route which helped to offset some of the sintering effects due to higher Fe/Sr loadings. The data for FIG. 12 is in Table 10 below.

TABLE 10

| | PV (cm³/g) | | | |
|---|---|---|---|---|
| | Temperature ° C. | | | |
| | 1000° C. for | | 1000° C. for | |
| | 10 hrs in | 1100° C. for | 10 hrs in | 1100° C. for |
| | Air L/R | 10 hrs in Air | Air L/R | 10 hrs in Air |
| Sample ID | (3% Pd) | (3% Pd) | (0.5% Rh) | (0.5% Rh) |
| Example 1 | 0.48 | 0.44 | 0.50 | 0.42 |
| Example 2 | 0.30 | 0.23 | 0.38 | 0.26 |
| Example 3 | 0.31 | 0.46 | 0.55 | 0.55 |
| Example 4 | 0.21 | 0.31 | 0.27 | 0.40 |
| Example 5 | 0.22 | 0.31 | 0.31 | 0.35 |
| Example 6 | 0.10 | 0.20 | 0.19 | 0.27 |
| Example 7 | 0.11 | 0.15 | 0.13 | 0.22 |

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained.

Notwithstanding that the numerical ranges and parameters setting forth the broad scope of the technology are approximations, the numerical values set forth in the specific examples are reported as precisely as possible. Any numerical value, however, inherently contain certain errors necessarily resulting from the standard deviation found in their respective testing measurements.

It will be clear that the compositions and methods described herein are well adapted to attain the ends and advantages mentioned as well as those inherent therein. Those skilled in the art will recognize that the methods and systems within this specification may be implemented in many manners and as such are not to be limited by the foregoing exemplified embodiments and examples. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope contemplated by the present disclosure. Numerous other changes may be made which will readily suggest themselves to those skilled in the art and which are encompassed in the spirit of the disclosure.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as disclosed. Thus, it is intended that the present invention include modifications and variations that are within the scope of the appended claims and their equivalents.

What is claimed is:

1. A mixed oxide composition comprising:
a) about 3 to about 40 wt. % lanthanum on an oxide basis;
b) about 50 to about 77 wt. % aluminum on an oxide basis;
c) about 0.05 wt. % to about 15.00 wt. % iron on an oxide basis;
d) about 0.02 wt. % to about 5.00 wt. % strontium on an oxide basis;
e) optionally up to 99 wt. % of the lanthanum can be substituted with an optional rare earth selected from the group consisting of neodymium, yttrium, praseodymium, samarium, gadolinium, and mixtures thereof, wherein the total amount of lanthanum and optional rare earth are in an amount of about 3 to about 40 wt. % on an oxide basis;
f) optionally up to 99 wt. % of the iron can be substituted with any transition metal (TM) dopant selected from the group consisting of manganese, chromium, cobalt, vanadium, copper, titanium, zinc, and mixtures thereof, wherein the total amount of iron and the transition metal dopant when present are in an amount of about 0.05 to about 15.00 wt. % on an oxide basis; and
g) optionally up to 99 wt. % of the strontium can be substituted with an alkaline earth (AE) metal dopant selected from the group consisting of magnesium, calcium, and mixtures thereof, wherein the total amount of strontium and the alkaline earth metal dopant when present are in an amount of about 0.02 to about 5.00 wt. % on an oxide basis.

2. The mixed oxide composition of claim 1, wherein the lanthanum, iron, and strontium are not substituted.

3. The mixed oxide composition of claim 1, wherein the composition comprises about 72% aluminum, about 20 wt. % lanthanum, about 6.5% iron, and about 1.5% Sr, all on an oxide basis.

4. The mixed oxide composition of claim 1, wherein the mixed oxide composition exhibits a primary perovskite phase and a secondary perovskite phase.

5. The mixed oxide composition of claim 4, wherein the mixed oxide composition exhibits a primary LaAlO₃ perovskite phase and additional perovskite phases fitting the formula: LaAl_{(1-y)}Fe_{y}O₃ or La₍₁₋ₓ₎Sr₍ₓ₎Al_{(1-y)}Fe_{(y)}O₃ where the primary X-ray diffraction peaks at 2θ typically fall at about 33° as the LaAlO₃ primary peak, and x is the molar ratio of Sr and is about 0.001 to about 0.999 and y is the molar ratio of Fe and is about 0.001 to about 0.999.

6. The mixed oxide composition of claim 4, which includes a primary phase LnAlO₃ and additional perovskite phases fitting the general formulae Ln₍₁₋ₓ₎AE_{X}TMO₃, LnAl_{(1-y)}TM_{(y)}O₃, or Ln₍₁₋ₓ₎AE₍ₓ₎Al_{(1-y)}TM_{(y)}O₃ where Ln is lanthanum, neodymium, yttrium, praseodymium, samarium, gadolinium, or a mixture thereof; AE is strontium, magnesium, calcium, or a mixture thereof; and TM is iron, manganese, or chromium, and x is the molar ratio amount of AE and is a value of about 0.001 to about 0.999 and y is the molar ratio of TM and is a value of about 0.001 to about 0.999.

7. The mixed oxide composition of claim 6, wherein the mixed oxide composition exhibits a primary LnAlO₃ perovskite phase and secondary perovskite phases Ln₍₁₋ₓ₎AE_{X}TMO₃, LnAl_{(1-y)}TM_{(y)}O₃, or Ln₍₁₋ₓ₎AE₍ₓ₎Al_{(1-y)}TM_{(y)}O₃ fresh/as manufactured and after aging at 1100° C. for 10 hrs in air, where Ln is lanthanum, AE is strontium, and TM is iron.

8. The mixed oxide composition of claim 6, where both x and y are a value of 0 to about 1.

9. The mixed oxide composition of claim 6, wherein the primary LnAlO₃ perovskite phase is LaAlO₃.

10. The mixed oxide composition of claim 1, wherein SrFeO₃ is present.

11. The mixed oxide composition of claim 1, wherein the mixed oxide composition exhibits a BET surface area of about 30 m²/g to about 100 m²/g fresh/as manufactured and a BET surface area of about 30 m²/g to about 75 m²/g after aging at 1000° C. for 10 hrs in air.

12. The mixed oxide composition of claim 1, wherein the mixed oxide composition exhibits a BET surface area of about 15 m²/g to about 65 m²/g after aging at 1200° C. for 2 hrs in air.

13. The mixed oxide composition of claim 1, wherein the nitrogen pore volume as measured by the BJH method is about 0.2 cm³/g to about 0.6 cm³/g both fresh/as manufactured and after aging at 1100° C. for 10 hrs in air.

14. The mixed oxide composition of claim 1, wherein the mixed oxide composition has a LnAlO₃ crystallite size of about 5 nm to about 80 nm both fresh/as manufactured and after aging at 1100° C. for 10 hrs in air.

15. The mixed oxide composition of claim 1, having a particle size characterized by a D₉₀ of about 6 μm to about 30 μm and a D₁₀ of about 1 μm to about 4 μm.

16. The mixed oxide composition of claim 1, having pore sizes ranging from about 50 nm to about 200 nm in diameter.

17. The mixed oxide composition of claim 1, wherein after aging at 1100° C. for 10 hrs in air, or under lean/rich aging conditions at 1000° C. for 10 hrs, the mixed oxide composition exhibits an Oxygen Storage Capacity (OSC) measured at about 350° C. to about 800° C. that is about 10 to 90 times higher than a lanthanum alumina composition not containing iron and strontium.

18. The mixed oxide composition of claim 17, wherein the Oxygen Storage Capacity (OSC) is measured at about 400° C. to about 800° C. after aging at 1100° C. for 10 hrs in air or under lean/rich aging conditions at 1000° C. for 10 hrs.

19. The mixed oxide composition of claim 1, wherein aluminum is in the form of transitional alumina comprising γ-Al₂O₃, δ-Al₂O₃ and/or θ-Al₂O₃.

20. A catalyst or catalyst composition comprising the mixed oxide composition of claim 1.

21. A suspension comprising: (i) a Platinum Group Metal selected from the group consisting of platinum, palladium, rhodium, iridium, ruthenium, and mixtures thereof and (ii) a mixed oxide composition comprising:
a) about 3 to about 40 wt. % lanthanum on an oxide basis;
b) about 50 to about 77 wt. % aluminum on an oxide basis;
c) about 0.05 wt. % to about 15.00 wt. % iron on an oxide basis;
d) about 0.02 wt. % to about 5.00 wt. % strontium on an oxide basis;
e) optionally up to 99 wt. % of the lanthanum can be substituted with an optional rare earth selected from the group consisting of neodymium, yttrium, praseodymium, samarium, gadolinium, and mixtures thereof, wherein the total amount of lanthanum and optional rare earth are in an amount of about 3 to about 40 wt. % on an oxide basis;
f) optionally up to 99 wt. % of the iron can be substituted with any transition metal (TM) dopant selected from the group consisting of manganese, chromium, cobalt, vanadium, copper, titanium, zinc and mixtures thereof, wherein the total amount of iron and the transition metal dopant when present are in an amount of about 0.05 to about 15.0 wt. % on an oxide basis; and
g) optionally up to 99 wt. % of the strontium can be substituted with an alkaline earth (AE) metal dopant selected from the group consisting of magnesium, calcium and mixtures thereof, wherein the total amount of strontium and the alkaline earth metal dopant when present are in an amount of about 0.02 to about 5.00 wt. % on an oxide basis.

22. The suspension of claim 21, wherein the suspension comprises about 30 wt. % to about 80 wt. % of the mixed oxide composition.

23. The suspension of claim 21, wherein the Platinum Group Metal comprises rhodium, and the suspension comprises about 0.2 wt. % to about 1.50 wt. % rhodium as metal on a mixed oxide basis.

24. The suspension of claim 21, wherein the Platinum Group Metal comprises palladium and the suspension comprises about 0.5 wt. % to about 4.0 wt. % palladium as metal on a mixed oxide basis.

25. The suspension of claim 21, further comprising pseudoboehmite.

26. The mixed oxide composition of claim 1, wherein the mixed oxide composition contains less than 0.01 wt. % barium, cerium, mercury, and cadmium.
